(19) United States
(12) Patent Application Publication
(10) Pub. No.: US 2026/0105241 A1
(43) Pub. Date: Apr. 16, 2026

(54) SYSTEMS AND METHODS FOR SELECTING A TEXT STYLE TO DISPLAY IN AN AR ENVIRONMENT BASED ON PREDICTED LIGHTING CONDITIONS

(71) Applicant: Adeia Guides Inc., San Jose, CA (US)

(72) Inventors: Aldis Sipolins, Somerville, MA (US); Mathew Adams, Matthews, NC (US); Charles Dasher, Lawrenceville, GA (US); Tao Chen, Palo Alto, CA (US); Evgeny Kaminsky, Hollywood, FL (US)

(21) Appl. No.: 18/912,067

(22) Filed: Oct. 10, 2024

(51) Int. Cl. G06F 40/109; G06T 11/60; G06T 19/00

(52) U.S. Cl. CPC G06F 40/109; G06T 11/60; G06T 19/006

(57) ABSTRACT

Systems and methods are provided for selecting a text style to display in an augmented reality (AR) environment based on predicted lighting conditions. The systems and methods may determine current lighting conditions for a real-world location at a current time and retrieve historical lighting data. Predicted lighting conditions may be determined for a time period after the current time. Based on the current and predicted lighting conditions, a text style for text to be displayed within an AR environment over the time period may be selected. The text may be generated for display in the selected text style within the AR environment.

### BACKGROUND

This disclosure is directed to systems and methods for selecting a text style to display in an augmented reality (AR) environment based on predicted lighting conditions.

### SUMMARY

Augmented reality (AR) experiences blend aspects of the physical, real-world with digital elements such as virtual text and virtual objects. AR applications running AR systems may display informational text, advertising text, instructional text, descriptive text, etc. However, AR can have a contrast problem: if an appearance of text displayed in an AR environment does not sufficiently contrast the real-world background (which may be frequently changing during an AR session), such text may not be sufficiently visible and/or legible. Attempts to improve text legibility in AR often require a one-size-fits-all approach, which sacrifices field of view or user interface (UI) design. In one approach, AR systems may increase text size displayed in AR environments. While increasing the text size may improve legibility, the large text may occlude more of the background. Not only does the occlusion of the background potentially limit the field of view of the real-world environment, it also increases the probability that the text will lack sufficient contrast since the text is more likely to cover a greater array of background colors. Additionally, this approach does not generalize to all possible background colors. As soon as the background changes, such as if a user turns their head to look at a different portion of their environment, text legibility is no longer guaranteed.

In another approach, AR systems may overlay banners with contrasting color behind the text to ensure readability. While this approach may improve text legibility, the banner may take up a large portion of the field of view of the AR environment, again occluding potentially salient portions of the AR environment or real-world environment a user may desire to interact with or view. In another approach, lighting in an AR environment is constantly analyzed during every (or nearly every) frame during an AR session as part of processing an AR scene. However, such an approach consumes a significant amount of computing resources and may contribute to quickly draining battery life, such as of an AR head-mounted device providing the AR scene. There is a need for improved techniques for ensuring the readability of text overlaid in AR environments by considering environmental features such as spatial arrangement, changing lighting conditions, and tradeoffs to occlusion and UI design, and to more efficiently obtain and utilize lighting data of an AR scene when selecting a text style.

To help address these problems, the systems, methods, and apparatuses disclosed herein may be configured to select a text style to display in an AR environment based on predicted lighting conditions. In some implementations, an AR system determines current lighting conditions for a real-world location at a current time. For example, at 5 pm, an AR device running the AR system determines that the living room of an AR user (e.g., the location where the AR device is at 5 pm) is filled with sunlight. As another example, the AR system may determine that a certain room dims its lights at the same time each day or on certain days (e.g., a casino, restaurant, or bar). In some embodiments, the AR system retrieves historical lighting data for the real-world location. The historical lighting data may comprise a plurality of lighting characteristics for a plurality of previous times, respectively, wherein each lighting characteristic is associated with at least one of a time of day or weather conditions at the corresponding previous time. For example, the historical lighting data for the living room may comprise an average luminance for the living room over at least one time period before the current time (e.g., the luminance of the living room for each hour over the past 24 hours).

In some implementations, the AR system determines, based at least in part on the historical lighting data, predicted lighting conditions over a time period after the current time. For example, based on the luminance of the living room over the past 24 hours, the AR system predicts that the luminance of the living room will decrease between 5-8 pm due to shadows created by the setting sun against one of the walls of the living room. Such aspects allow the AR system to select a text style that will remain legible even as lighting conditions change. Moreover, by determining and employing predictions of future lighting for a given environment, e.g., based on historical lighting data for such environment, computing may be performed less frequently (e.g., at the beginning of an AR session), thereby conserving computing resources and battery life of an AR device. The AR system may determine the time period based at least in part on a predicted AR session length. For example, the AR system determines, based on previous AR session data, that the AR sessions on the AR device last, on average, three hours. Thus, when an AR session begins at 5 pm, the AR system determines that the time period will end at 8 pm. In some embodiments, based at least in part on the historical lighting data for the real-world location and the current lighting conditions for the real-world location, the AR system generates a lighting condition model comprising at least one neural network. The AR system may use the lighting condition model to determine the predicted lighting conditions over the time period.

Prior to determining the predicted lighting conditions, the AR system may train the at least one neural network using the historical lighting data for the real-world location. In some implementations, the AR system inputs data indicative of the current lighting conditions, the time period, and at least one of the time of day or weather conditions of the current time to the trained at least one neural network. Such aspects reduce the need to regenerate the lighting condition model as lighting conditions change, thereby reducing computational load. The AR system may receive as output, from the trained at least one neural network, data indicating the predicted lighting conditions over the time period. Based at least in part on the current lighting conditions for the real-world location at the current time and the predicted lighting conditions over the time period, in some embodiments, the AR system selects a text style for text to be displayed within an AR environment over the time period. The AR environment may be the real-world environment plus additional AR objects and text, as seen through an interface of the AR device running the AR system.

The AR environment may comprise the text overlaid on the real-world location. For example, the AR system may overlay text on one of the walls of the living room as an advertisement for a sponsor of the AR application (e.g., “20% off socks from sockworld.com”). Based on the predicted lighting conditions over the time period (e.g., decreasing brightness from 5-8 pm), the AR system may select a lighter text color for the text that contrasts well with the darker background. In some implementations, the AR system generates for display the text, in the selected text style, within the AR environment over the time period. For example, the AR system displays “20% off socks from sockworld.com” on one of the walls of the living room between 5-8 pm in the selected text color. The selected text style may be maintained in the AR environment throughout the time period.

In some implementations, the selected text style is a first selected text style displayed at a first time during the time period. During the time period, the AR system may select a second text style for the text based at least in part on the predicted lighting conditions over the time period. For example, based on predicted decreasing luminance over the time period, the AR system selects a second, lighter text color. In some embodiments, the AR system generates for display the text, in the second selected text style, within the AR environment during the time period, wherein the second time is later than the first time. For example, while at 6 pm the AR system displays the text in a dark pink, at 8 pm the AR system displays the text in a lighter pink. In some embodiments, the AR system gradually transitions from the first selected text style to the second selected text style. Such aspects ensure legibility in a smooth, continuous manner and would require fewer computing resources than continuously updating text color based on the current background color.

In some embodiments, the AR system identifies a plurality of text styles. For example, the AR system identifies, from a database of text styles, a plurality of text color and text texture options. For a portion of the AR environment at which the text is to be placed, in some implementations, the AR system determines a color of the portion at the current time and the predicted lighting conditions over the time period for the portion. For example, the AR system determines that a wall of the living room (i.e., a portion of the AR environment at which the text is to be placed) is beige at 5 pm and predicts that the luminance of the wall will decrease between 5-8 pm.

In some embodiments, the AR system calculates a contrast ratio between each of the plurality of text styles and the color and the predicted lighting conditions of the portion of the AR environment. The AR system may determine a predicted color based on the current color and the predicted lighting conditions. For example, the AR system may calculate a contrast ratio of 500:1 for one text style and the color at the current time and 300:1 for the text style and the predicted color. In some implementations, the AR system selects, as the text style, a text style of the plurality of text styles exceeding a contrast threshold. The contrast threshold may be predetermined by the AR system. For example, the AR system selects a particular text style with contrast ratios that exceed, e.g., 300:1. In some embodiments, based at least in part on the current lighting conditions for the real-world location at the current time and the predicted lighting conditions over the time period, the AR system selects a position within the AR environment to display the text. The text may be generated for display, in the selected text style, at the position within the AR environment.

In some implementations, the AR system determines, for each respective portion of a plurality of portions of the real-world location, a likelihood of lighting conditions changing. For example, the AR system determines that the top portion of a wall in the living room has a low likelihood of changing lighting conditions (e.g., consistent predicted lighting condition), while the bottom portion of the wall has a high likelihood of changing lighting conditions (e.g., inconsistent predicted lighting changes). In some embodiments, the AR system selects a position in the AR environment to insert the text that corresponds to a portion of the plurality of portions having a likelihood of changing lighting conditions that is below an inconsistency threshold. For example, the AR system selects the top portion of the wall to generate for display the text because the AR system determined that the top portion has a likelihood of changing lighting conditions below an inconsistency threshold (e.g., a low likelihood of changing lighting conditions). Such aspects reduce computing resources required to adjust text color over the time period.

In some implementations, the AR system retrieves user preference data from a user profile associated with the AR device. The AR system may select the text style for the text based at least in part on the user preference data. For example, a user of the user profile may include or indicate user preference data. Example user preferences may be preferences explicitly set for, e.g., a particular font, other text style; or a user preference for a text style may be implicit or inferred, e.g., gleaned from past user interactions with the AR system (or other systems) or historical user selections or inputs with the AR system (or other systems). In some embodiments, the AR system selects the text style based on whether the text is on a same depth plane as at least one other object in the AR environment. For example, the AR system may determine that there is wall decor on the wall of the living room that may decrease legibility of the text displayed on the wall. The AR system may generate for display the text in a bolder style to improve legibility. In some implementations, the AR system generates for display the text on a different depth plane than the other object to improve legibility. In some embodiments, the AR system modifies a color of a portion of the AR environment on which the selected text is displayed. For example, the AR system may modify the color of the wall on which the text is displayed in order to stay aligned with brand guidelines from sockworld.com (e.g., that text color must be an approved color of the brand).

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative example of selecting a text style to display in an AR environment based on predicted lighting conditions, in accordance with some embodiments of this disclosure.

FIG. 2 shows an illustrative example of selecting a second text style for a second time based on predicted lighting conditions, in accordance with some embodiments of this disclosure.

FIG. 3 shows an illustrative example of rendering a three-dimensional (3D) text object for display, in accordance with some embodiments of this disclosure.

FIG. 4 shows an illustrative example of predicting changes to the spatial arrangement of detected planes based on semantic segmentation or historical patterns, in accordance with some embodiments of this disclosure.

FIG. 5 shows an illustrative example of generating for display text in a textured text style, in accordance with some embodiments of this disclosure.

FIG. 6 shows an illustrative example of applying a parallax effect to text, in accordance with some embodiments of this disclosure.

FIG. 7 shows an illustrative example of blurring rough background textures to increase text legibility, in accordance with some embodiments of this disclosure.

FIG. 8 depicts an illustrative user equipment device, in accordance with some embodiments of this disclosure.

FIG. 9 depicts an illustrative user equipment device, in accordance with some embodiments of this disclosure.

FIG. 10 is a flowchart of an illustrative process for selecting a text style to display in an AR environment based on predicted lighting conditions, in accordance with some embodiments of this disclosure.

FIG. 11 is a flowchart of an illustrative process for selecting a text style to display in an AR environment based on predicted lighting conditions, in accordance with some embodiments of this disclosure.

FIG. 12 is a flowchart of an illustrative process for rendering an AR text object, in accordance with some embodiments of this disclosure.

FIG. 13 is a flowchart of an illustrative process for rendering an AR text object, in accordance with some embodiments of this disclosure.

FIG. 14 is a sequence diagram of an illustrative process for selecting a text color based on predicted lighting changes, in accordance with some embodiments of this disclosure.

FIG. 15 is a sequence diagram of an illustrative process for selecting a texture for text based on the noise and texture of the background behind the text, in accordance with some embodiments of this disclosure.

FIG. 16 is a sequence diagram of an illustrative process for blurring rough background textures to increase text legibility, in accordance with some embodiments of this disclosure.

FIG. 17 is a sequence diagram of an illustrative process for selecting a font color for text overlaid on images by analyzing dominant colors in the background using a color histogram, in accordance with some embodiments of this disclosure.

### DETAILED DESCRIPTION

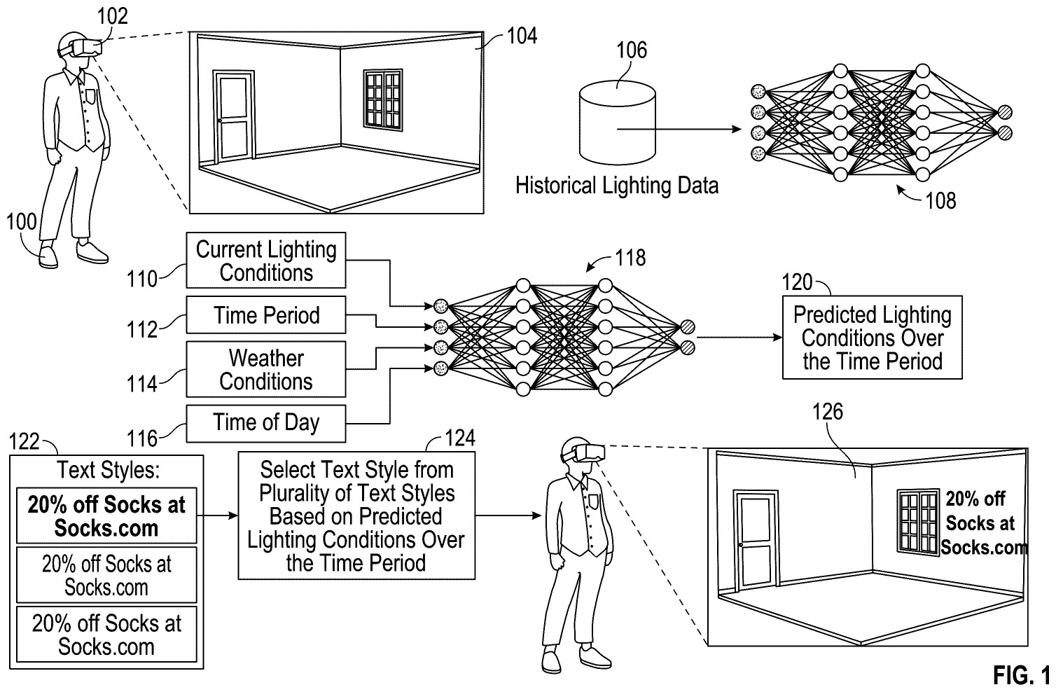

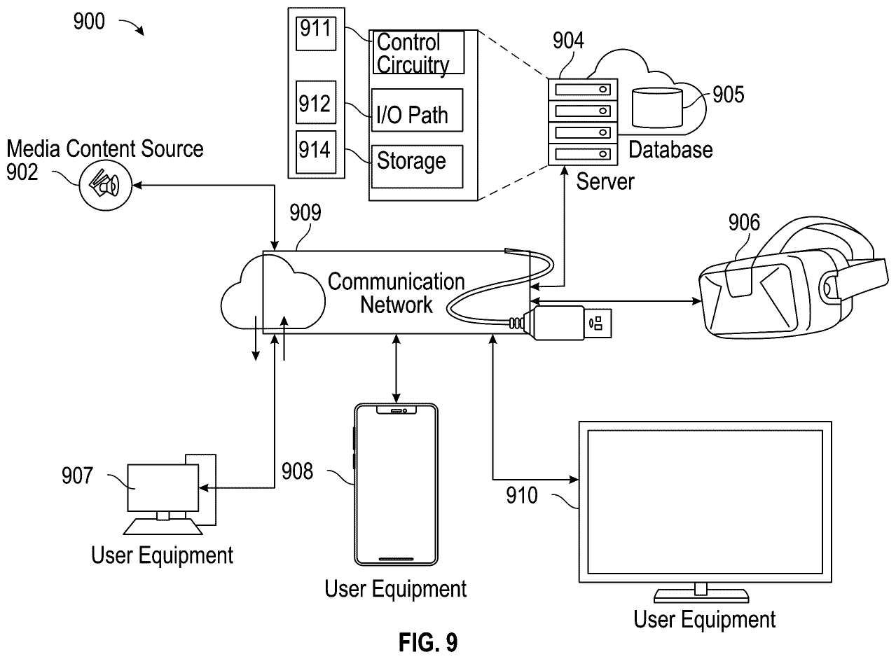

FIG. 1 shows an illustrative example of selecting a text style to display in an AR environment based on predicted lighting conditions, in accordance with some embodiments of this disclosure. FIG. 1 illustrates an AR system configured to perform various functionalities described herein. In some embodiments, the AR system comprises or corresponds to an application that may be executed at least in part on a server (e.g., media content source 902 and/or one or more servers 904 of FIG. 9), a user equipment device (e.g., head-mounted display (HMD) 102 of FIG. 1, devices 906, 907, 908, 910, and/or 915 of FIG. 9, such as, for example, a laptop computer, a personal computer, a desktop computer, a smart television, a smart watch or wearable device, smart glasses, a stereoscopic display, a wearable camera, extended reality (XR) glasses, XR goggles, an XR glove, a near-eye display device), any other suitable user equipment or computing device, or any combination thereof. The application and/or AR system may comprise or employ any suitable number of displays, sensors, or devices such as those described herein, or any other suitable software and/or hardware components, or any combination thereof. In some embodiments, HMD 102 is a pass-through or see-through AR device.

In some embodiments, the AR system generates for display an AR environment (e.g., AR environment 104) via an AR device (e.g., HMD 102). In some implementations, AR environment 104 is generated for display by a third-party application, a third-party system, any other suitable AR provider, or any combination thereof. An AR user (e.g., AR user 100) may wear HMD 102 in a real-world location, e.g., the living room of AR user 100. The AR system may determine the real-world location via the IP address of HMD 102, GPS coordinates of HMD 102, a Wi-Fi network, a cellular network, based on input provided by AR user 100, any other suitable geolocation technique, or any combination thereof. In some embodiments, the AR system determines current lighting conditions for the real-world location at a current time. The AR system may determine lighting conditions for the living room of AR user 100 from online weather data, from real-time analysis via a camera and/or sensor of HMD 102, from a camera or sensor external to HMD 102 (e.g., a home security camera that captures footage of a particular room) any other suitable lighting condition detection method, or any combination thereof. The AR system may determine the current time via Real Time Clock (RTC) circuitry from HMD 102. For example, the AR system determines that AR user 100 is using HMD 102 to generate for display AR environment 104 at 5 pm on a sunny day at a certain time of year (e.g., a specific date, or a particular season, such as, for example, winter, spring, summer, or autumn). In some embodiments, a camera of HMD 102 detects light rays streaming into AR environment 104.

In some implementations, the AR system retrieves historical lighting data (e.g., historical lighting data 106) for the real-world location and/or other real-world locations (e.g., similar geographic locations or locations with other similar attributes, such as if historical data for real-world environment is not yet available). Historical lighting data 106 may be stored in a database of HMD 102, in a remote server which communicates with the AR system, any other suitable storage, or a combination thereof. The historical lighting data may comprise a plurality of lighting characteristics for a plurality of previous times, respectively, wherein each lighting characteristic is associated with at least one of a time of day or weather conditions at the corresponding previous time. In some implementations, the historical lighting data comprises an average luminance for the real-world location over at least one time period before the current time. For example, each time AR user 100 has previously used HMD 102 in the living room of AR user 100, the AR system stores the lighting data in memory of HMD 102. For example, the lighting of the living room at 5 pm on prior days may be approximately 2,000 lumens. In some embodiments, other user devices, such as a smartphone, collects lighting data using sensors of the user device. In some embodiments, the AR system trains at least one neural network (e.g., neural network 108) using historical lighting data 106 for the real-world location. The AR system may train neural network 108 using machine learning, such as support vector machines (SVMs), multilayer perceptrons (MLPs), convolutional neural networks (CNNs), any other suitable machine learning algorithm, or any combination thereof.

Based at least in part on the historical lighting data for the real-world location and the current lighting conditions for the real-world location, in some embodiments, the AR system generates a lighting condition model comprising neural network 108 and/or trained neural network 118 and/or any other suitable components. In some embodiments, the AR system may utilize one or more portions of LiteAR, which estimates overall scene illumination in real-time to provide more realistic shading by using a dynamic irradiance map as a set of spherical harmonics and then training a light-weight neural network (e.g., trained neural network 118) on the dataset. LiteAR is discussed in more detail in Raut et al., “LiteAR: A Framework to Estimate Lighting for Mixed Reality Sessions for Enhanced Realism,” In: Magnenat-Thalmann, N., et al. Advances in Computer Graphics. CGI 2022. Lecture Notes in Computer Science, vol 13443. Springer, Cham, the contents of which are incorporated by reference herein in its entirety. Building on the LiteAR model, the AR system provides a shader (e.g., a program executable on a graphic processing unit (GPU) to process pixels and/or geometry data and/or depth data) to accurately illuminate the background surface at a set of points in time for a given AR session to provide a full series of predicted changes to the lighting of the background surface in the real-world environment. These re-illuminated background surface images can then be used by the AR system to determine the text style to be used through the duration of the time period. The AR system may input additional context to trained neural network 118 for the current lighting conditions (e.g., current lighting conditions 110, the time period (e.g., time period 112), and at least one of the time of day (e.g., time of day 116) or weather conditions (e.g., weather conditions 114) of the current time. In some embodiments, such additional context may be included in historical lighting data 106 (e.g., for each data point of lighting data on a certain historical date) used to train neural network 108. In some embodiments, the AR system uses the lighting condition model not only for creating real-time shading but also for predicting future shading requirements for a given surface (e.g., predicted lighting conditions over the time period 120).

In some embodiments, the lighting condition model works across multiple time of day scenarios for a given location without a need to change the coloring or shading of a text object in reaction to the changing lighting conditions. The AR system may continually train trained neural network 118 based on interactions by AR user 100 with the AR system. In some embodiments, when AR user 100 more consistently uses HMD 102, the lighting condition model becomes more accurate based on historical lighting data 106 derived from AR user 100's own activities. The AR system may generate the lighting condition model based on the input data and/or based on prior input data (e.g., historical lighting data 106). The lighting condition model is trained to learn lighting patterns for the real-world location to then predict future lighting conditions for such location or similar locations. The AR system may determine time period 112 based at least in part on a predicted AR session length. For example, the AR system determines, based on previous AR session data, that the AR sessions on HMD 102 last, on average, for three hours. Thus, when AR user 100 starts an AR session on HMD 102 at 5 pm, the AR system determines that the AR session is likely to last until and end at 8 pm. Thus, time period 112 is predicted to be from 5 pm-8 pm.

In some embodiments, the AR system determines, based at least in part on the historical lighting data, predicted lighting conditions over a time period after the current time (e.g., predicted lighting conditions over the time period 120). The AR system may receive predicted lighting conditions over the time period 120 as output from trained neural network 118. For example, the AR system may receive data from trained neural network 118 indicating that a shadow is predicted to form on the wall of the living room around 6 pm. In some embodiments, the predicted lighting conditions comprise at least one of an average luminance for the real-world location over the time period, a light color, a light color temperature, a light hardness, shadow positioning, and/or any other suitable lighting condition data. Based at least in part on the current lighting conditions for the real-world location at the current time and the predicted lighting conditions over the time period, in some implementations, at 124, the AR system selects a text style for text to be displayed within AR environment 104 over the time period, wherein the AR environment comprises the text overlaid on the real-world location, as shown at 126. In some embodiments, the AR system selects the text style from a plurality of text styles (e.g., plurality of text styles 122) identified from a database of text styles. For example, the AR system may select a bolder text style so that the text will appear more legible against the shadow on the wall of the living room. In some embodiments, the AR system generates for display the text, in the selected text style, within the AR environment over the time period (e.g., AR environment 126). In some implementations, the selected text style is maintained in AR environment 126 throughout the time period indicated at 112.

In some implementations, via trained neural network 118, the AR system creates a unique lighting condition model for a set of time slices throughout the time period. The AR system may then apply the lighting condition models to the background surface the text is to be displayed in front of (e.g., the wall of the living room). The new set of images updated with the lighting condition models generated by the lighting condition model for each time slice may be used by the AR system to determine the text style of the text to display.

In some embodiments, based at least in part on the current lighting conditions for the real-world location at the current time and the predicted lighting conditions over the time period, the AR system selects at least one of a color or a texture for the text to be displayed within the AR environment. For example, the AR system may select a dark color for a portion of AR environment 126 for which the corresponding real-world location is predicted to remain bright. In another example, the AR system may select a blue color for a portion of AR environment 126 for which the corresponding real-world location is predicted to decrease in brightness over the time period. In some implementations, the AR system determines the predicted lighting conditions over the time period by determining, for each respective portion of a plurality of portions of AR environment 104 (e.g., the real-world location), a likelihood of changing lighting conditions. For example, the AR system determines that the top portion of a wall in the living room has a low likelihood of changing lighting conditions (e.g., consistent predicted lighting condition), while the bottom portion of the wall has a high likelihood of changing lighting conditions (e.g., inconsistent predicted lighting changes). Based at least in part on current lighting conditions 110 for the real-world location at the current time and predicted lighting conditions over the time period 120, the AR system selects a position within AR environment 126 to display the text, wherein the text is generated for display, in the selected text style, at the position within AR environment 126.

For example, the AR system selects a position within AR environment that is predicted to have the least amount of glare over the time period. For example, glare may be understood as brightness concertation on a portion of an environment and glare may be determined to be present based on whether one or more pixels or voxels of an environment is determined to currently have, or is predicted to have, respective intensity values that exceed an intensity threshold. The AR system may also select a position predicted to have the least amount of brightness or shadow over the time period. In some embodiments, the AR system selects a position in AR environment 126 to insert the text that corresponds to a portion of the plurality of portions having a likelihood of changing lighting conditions that is below an inconsistency threshold. For example, the AR system selects the top portion of the wall to generate for display the text because the AR system determined that the top portion has a likelihood of changing lighting conditions below an inconsistency threshold (e.g., no likelihood of changing or a low likelihood of changing, such as based on determining that such portion is not near any windows or other light sources). The AR system may determine the likelihood of changing lighting conditions based on historical lighting data 106. For example, historical lighting data 106 may inform the AR system that the top portion of the wall has inconsistent lighting 20% of the time (e.g., consistent luminance during 8 of 10 prior AR sessions and inconsistent luminance in the other 2 sessions), while the bottom portion of the wall has inconsistent lighting 80% of the time (e.g., consistent lighting during only 2 of 10 prior AR sessions). In some embodiments, the inconsistency threshold is 40% (e.g., a position or area is only selected if it has inconsistent lighting at most 40% of the time). In other instances, the likelihood of changing inconsistency threshold may be set to require more consistent lighting conditions (e.g., 20%, 5%, 1% etc.) or to require less consistent lighting conditions (e.g., 80%) for selecting a position or area. In some embodiments, for a given AR session, the AR system sets an inconsistency threshold for the given AR session based on the AR session length. For example, an AR session that is predicted to last 1 hour may have an inconsistency threshold of, e.g., 30% (e.g., the lighting stays consistent for 60% of the AR session). In another example, AR session predicted to last 20 minutes may have an inconsistency threshold of, e.g., 5% (e.g., the lighting stays consistent for 90% of the AR session).

In some implementations, for a portion of AR environment 126 at which the text is to be placed, the AR system determines a color of the portion at the current time and predicted lighting conditions over the time period 120 for the portion. For example, the AR system determines (e.g., based on pixel analysis) that a wall of the living room is beige at 5 pm and predicts that the luminance of the wall will decrease between 5-8 pm. The AR system may identify the color of the portion using color hexadecimal codes, e.g., “#F5F5DC.” In some embodiments, the AR system calculates a contrast ratio between each of the plurality of text styles 122 and the color and predicted lighting conditions over the time period 120 of the portion of AR environment 126. The AR system may determine a predicted color based on the current color and predicted lighting conditions over the time period 120. For example, the AR system may calculate a contrast ratio of 500:1 for one text style and the color at the current time and 300:1 for the text style and the predicted color. In some implementations, the AR system selects, as the text style, a text style of plurality of text styles 122 exceeding a contrast ratio threshold. The contrast ratio threshold may be predetermined by the AR system. For example, the AR system selects a particular text style with contrast ratios that exceed a contrast ratio threshold of, e.g., 300:1.

In some embodiments, the AR system considers the spatially varying environment, especially around the AR text, to facilitate increased AR immersion. The AR system may also consider geometric estimation of the scene, e.g., by using an integrated light detection and ranging (LIDAR) sensor to capture depth images. In some embodiments, the geometric estimation may be based on estimating structure from motion with the help of camera images from multiple angles and sensor data, estimating depth from a single image have filled in the role of depth estimation, and/or using any other suitable technique. As many mixed reality sessions devote certain computational power to geometry estimation, the AR system may leverage the same for realistic relighting of virtual objects (e.g., AR text and/or AR objects) placed in the scene.

In Monte Carlo integration, every point queried from a sphere of certain radius surrounding the virtual object is treated as a point light source. However, since the distance between these points and the virtual object is less, the AR system may approximate integration to summation. The AR system down-samples the data uniformly. The AR system may arrange the point cloud data in a K-Dimensional tree (KDTree) data structure. The time complexity for querying neighbors is reduced from N to log N. The AR system may query all the points lying in a sphere of a certain radius. The AR system experiments with different values of this radius.

The AR system updates the spherical harmonic (SH) coefficients of the first two bands. The AR system may calculate irradiance in the form of spherical harmonic coefficients using the color of the point and its distance from the object. To obtain the local SH coefficient, the AR system integrates weighted irradiance based on distance over all of the points in the ball point query. Equations 1-3 use queried points and their radiance values to update the local spherical harmonics of band 1. The update to the logic includes factoring in the normalized values for time of day and ambient lighting values. Since the AR system will continue to update trained neural network 118 with updated AR user data, these two additional values are key to balance new data with the existing data trained neural network 118 was initially trained on.

| Symbol | Variable |
|---|---|
| SHlm | Spherical harmonics coefficient l of band l |
| L | Radiance at the point |
| R | Radius of the sphere |
| r | Distance of a point from the center of the sphere |
| Sign(d) | Function that outputs −1 or 1 depending on which side of |
| | the center the point lies along axis d |
| SHg | Global Spherical harmonics coefficients |
| SHl | Local Spherical harmonics coefficients |
| D | Maximum distance between any two points in the |
| | point cloud dataset |
| y | SH band 2 with 5 components |
| P | Function which projects a normal vector into the second |
| | band of spherical harmonics. It takes a normalized three |
| | dimensional vector as input and outputs a 5 dimensional SH |
| | vector. |
| M | 3 × 3 rotation matrix; the rotation that will be applied to the |
| | SH vector |
| U | The 5 × 5 (unknown) rotation matrix to apply to y |
| N | Set of five three-dimensional normalized vectors |
| T | Normalized time of day |
| A | Normalized ambient lighting value for environment |

$$SH 10 = \sum ( L * ( T * A ) * ( R - r ) / R ) * sign ( x ) \qquad 1 )$$

$$SH 11 = \sum ( L * ( T * A ) * ( R - r ) / R ) * sign ( y ) \qquad 2 )$$

$$SH 12 = \sum ( L * ( T * A ) * ( R - r ) / R ) * sign ( z ) \qquad 3 )$$

Where R is the radius of the sphere, the AR system queries points from the sphere. These local coefficients are used to update global SH coefficients based on a distance measure, as shown in Equation 5. Alpha is the measure of distance, which is calculated using Equation 4.

$$Alpha = R / D \qquad 4 )$$

$$SHg = alpha * SHg + ( 1 - alpha ) * SHl \qquad 5 )$$

Panoramic images capture more details in the horizontal direction since the distribution of radiance varies more in the horizontal direction. In an AR session, AR user 100 places a virtual object in the scene captured by the camera. After the object is placed in the environment, object illumination may change if the object is moved and placed somewhere else or if there is some change in the environment. To keep track of the scene, the AR system may use sparse optical flow. Even if the scene itself does not change, if AR user 100 moves around the object, the illumination may change because of the rotation.

With a light neural network combined with spherical harmonics rotation based on the input from the IMU sensor, the whole pipeline is AR headset-friendly, being able to render lighting condition models at high frame rates. Instead of calling trained neural network 118 every frame, to make the pipeline even lighter, the AR system may use spherical harmonics rotation based on IMU sensor input. In some embodiments, the rotation operation only requires less than 120 multiply accumulates compared to millions for calling the neural network, therefore reducing the computational load across the length of the AR session.

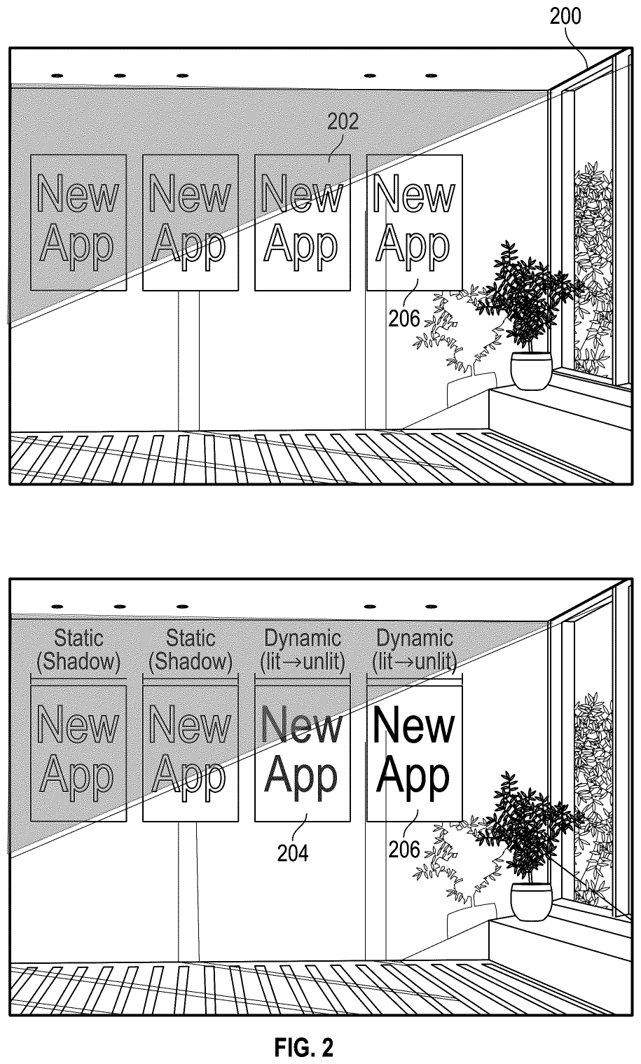

FIG. 2 shows an illustrative example of selecting a second text style for a second time based on predicted lighting conditions, in accordance with some embodiments of this disclosure. In some embodiments, an AR system (e.g., the AR system of FIG. 1) generates for display text (e.g., text 202) on a plane surface of a real-world object that is displayed within an AR environment (e.g., AR environment 200). For example, the AR system generates for display text 202 (“New App”) four times on the wall of a living room in AR environment 200 in a first text style (e.g., white font). However, text 202, in its given text style (e.g., white font), becomes less legible when read displayed on the portion of the wall covered in sunlight. The white font lacks contrast with the light-colored wall. In some embodiments, the AR system may avoid displaying illegible text by selecting a plurality of text styles to generate for display at a plurality of times within a time period based on predicted lighting conditions.

In some implementations, the selected text style (e.g., as described above in connection with FIG. 1) is a first selected text style displayed at a first time during the time period (e.g., 8 am-12 pm). For example, the AR system selects white font as the text style for a first time (e.g., 8 am) when the lighting conditions result in the wall of the living room being covered in shadow. During the time period, in some embodiments, the AR system selects a second text style for the text, based at least in part on the predicted lighting conditions over the time period. For example, the AR system predicts that the lighting conditions of the wall will increase in brightness between 8 am and 12 pm as the sun rises and shines on the wall of the living room. Based on the angle of the light coming through a window onto the wall, the AR system may predict that part of the wall will be in shadow while part of the wall will be in light. Based on these predicted lighting conditions, the AR system may select at least one additional text style for the text (e.g., a darker colored font that will appear more legible against the light-colored wall).

In some embodiments, the AR system generates for display the text, in the second selected text style, within AR environment 200 at a second time during the time period, wherein the second time is later than the first time. For example, the AR system generates for display text in a second text style (e.g., text 204) at, e.g., 11 am, when the sunlight makes the color of the wall appear lighter. In some implementations, the AR system generates for display the text in a third selected text style at a third time during the time period, wherein the third time is later than the second time. For example, at 11:30 am, as the sun makes the color of the wall appear even lighter, the AR system may select a black font text style to display the text (e.g., text 206).

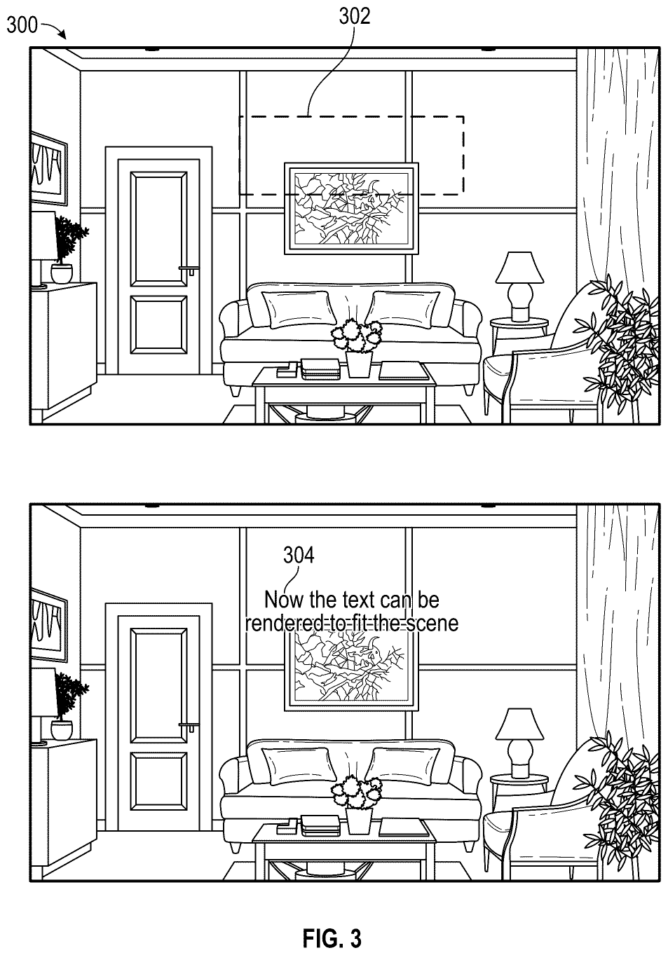

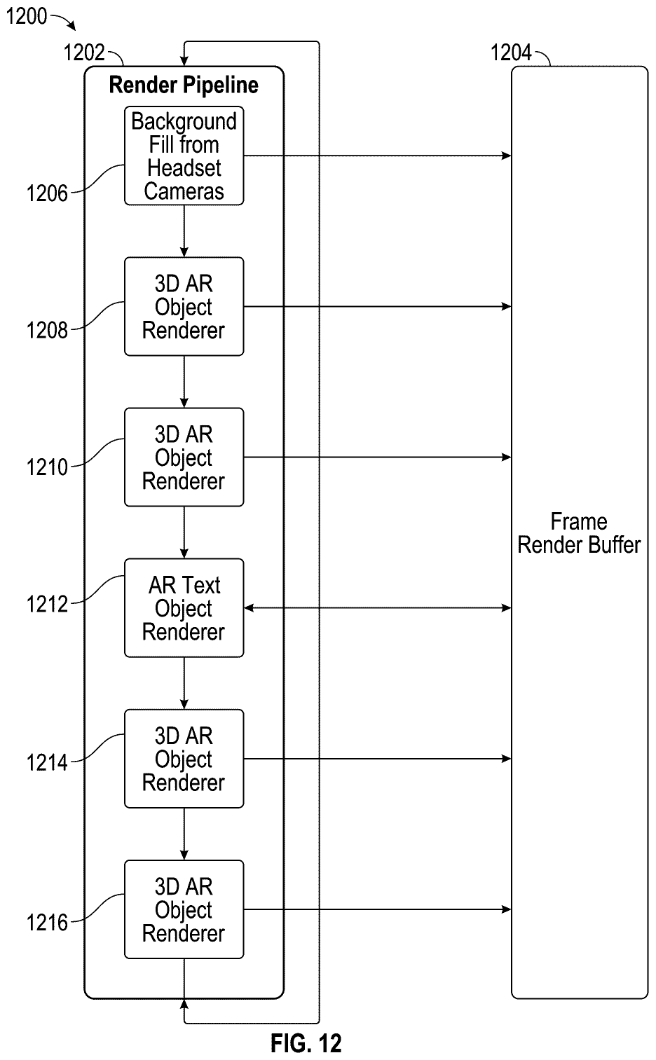

FIG. 3 shows an illustrative example of rendering a three-dimensional (3D) text object for display, in accordance with some embodiments of this disclosure. In some embodiments, an AR system (e.g., the AR system of FIG. 1) generates for display text (e.g., text 304) on a plane surface of a real-world object that is displayed within an AR environment (e.g., AR environment 300). The AR system may utilize an AR text rendering subsystem that selects, mathematically, where text 304 will be rendered to in the rendered frame buffer, which contains the actual pixels that the AR user (e.g., AR user 100 of FIG. 1) will see. The location of text 304 may be the result of a rendering pipeline (e.g., Render Pipeline 1202 as described below in connection with FIG. 12) that takes all of the two-dimensional (2D) and 3D objects in a scene and renders them to a 2D plane for display with the correct lighting and post processing effects.

For pass-through AR, the AR system may render text 304 on top of the physical world that is passed through by cameras in the AR headset (e.g., HMD 102 of FIG. 1) to allow for the merging of the physical and virtual worlds. In some implementations, the AR system renders the 3D objects in the scene starting from the far clipping plane (as far away from the eye of AR user 100 as possible) and then continue to move towards the near clipping plane (closest to the eye of AR user 100 as possible). This allows the closer 3D objects to overwrite the more distant objects in the rendered frame buffer and make the rendered objects appear correctly to AR user 100. The 3D renderer determines the region that text 304 will be placed during the rendering loop for a given frame, which is passed to the evaluation engine to determine the best solution for rendering the text against the pixels in the defined region (e.g., region 302).

Region 302 of the rendered frame buffer, which may comprise text 304 and the real-world background, is to be written to at the time of this evaluation so that the evaluation logic has exactly what text 304 will be rendered over to analyze for the best possible solution for text 304 against the given background for that rendered frame. In some embodiments, the AR system performs the evaluation after the lighting and post-processing of all of the 3D objects has been completed to give the most accurate data for evaluation. In some implementations, where text 304 is anchored to a physical location in the scene, the AR system may perform an additional step of re-rendering for the bounding volume around text 304 to manage any instances of other 3D objects that are closer to the AR user's eyes so that the objects are in the correct viewing order. In some embodiments, where text 304 is an overlay and rendered on top of all of the other 3D objects, the AR system may not need to perform any additional rendering steps.

In some embodiments, the AR system uses the AR text object renderer (e.g., as shown and described in relation to 1208 of FIG. 12) to analyze the scene of AR environment 300 to determine a text style to then render and deliver to the frame render buffer for viewing by AR user 100. The text evaluation engine determines the text style and then renders text 304 in the rendering pipeline for display.

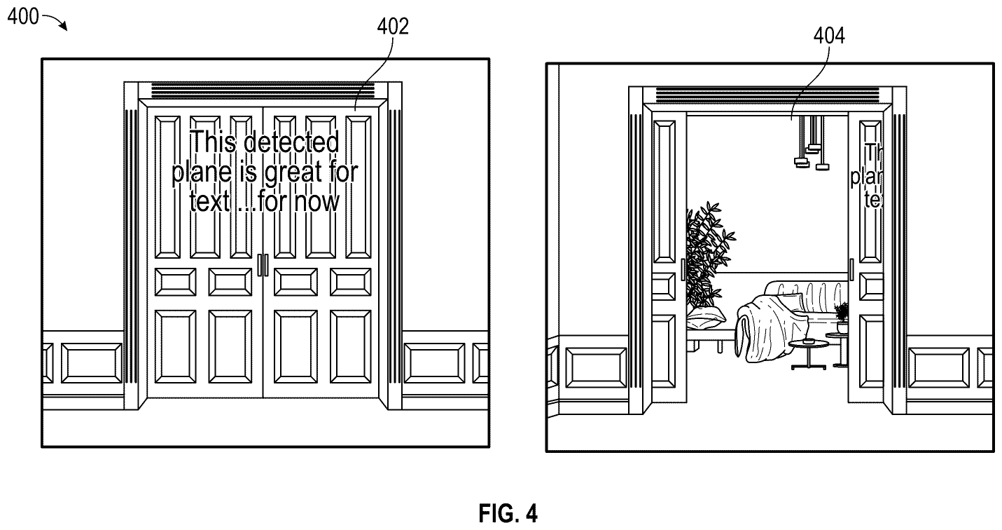

FIG. 4 shows an illustrative example of predicting changes to the spatial arrangement of detected planes based on semantic segmentation or historical patterns, in accordance with some embodiments of this disclosure. In some embodiments, an AR system (e.g., the AR system of FIG. 1) generates for display text on a plane surface of a real-world object that is displayed within an AR environment (e.g., AR environment 400). For example, the AR system may determine that a door (e.g., closed door 402) is an ideal plane on which to generate for display text. However, the AR system may determine that the door is frequently opened (e.g., open door 404). In some embodiments, the AR system determines the frequency of door opening based on historical AR session data. The AR system may determine, for example, that the door is typically opened and closed multiple times between the hours of 8 AM and 8 PM. Based on the high frequency of opening and closing, the AR system may not generate for display text on the area of AR environment 400 corresponding to the door. In some implementations, the AR system may generate for display the text on closed door 402 but not anchor the text on closed door 402. This allows the door to open without the text moving out of view.

In another example, the AR system may predict the likelihood that a detected surface (e.g., closed door 402) will change during the current AR session (e.g., at the current time of day or predicted duration). For example, the door may be frequently opened during the day but not at all after 1 AM. In this example, the AR system may not place the text on the detected door plane during the day but it may place text on the door plane late at night. The AR system may apply semantic segmentation techniques to identify objects that are likely to change their spatial arrangement. Semantic segmentation techniques may comprise fully convolutional networks (FCNs), DeepLab, Pyramid Scene Parsing Network (PSPNet), any other suitable semantic segmentation technique, or any combination thereof. In some embodiments, the AR system uses other image segmentation techniques such as color space segmentation. For example, using semantic segmentation, the AR system may determine that a door is likely to move as it is opened and closed but a framed painting has a low likelihood of moving. In some implementations, since the framed painting has a low likelihood of moving, the AR system may generate for display text on the framed painting as opposed to the door.

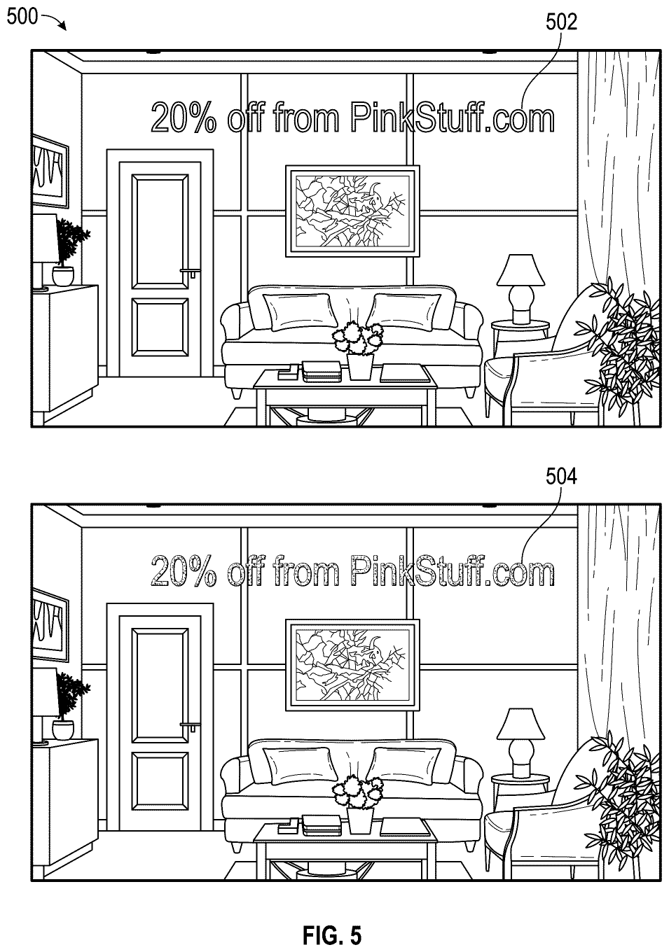

FIG. 5 shows an illustrative example of generating for display text in a textured text style, in accordance with some embodiments of this disclosure. In some embodiments, an AR system (e.g., the AR system of FIG. 1) generates for display text on a plane surface of a real-world object that is displayed within an AR environment (e.g., AR environment 500). For example, within AR environment 500, the AR system generates for display the text “20% off from PinkStuff.com” in pink text. For example, PinkStuff.com may be an advertiser partnered with the AR system. PinkStuff.com may require their advertising text to be pink to align with their branding. However, text 502 may be illegible due to the wall it is displayed on also being pink. Solid text color is effective when the fill color contrasts the background, but a textured font fill may enable the AR system to use a preferred color (e.g., for consistent branding) when the background color is similar.

In some embodiments, the AR system applies a suitable texture to the text based on the noise and texture of the background area behind it. The AR system selects a texture for the text that contrasts with the determined texture of the background (e.g., the wall of AR environment 500). The AR system may analyze the roughness texture of the background area using edge detection algorithms, such as the Sobel or Canny edge detectors which highlight areas with significant changes in intensity, indicating the presence of edges and fine details. Next, the AR system may perform frequency analysis by converting the segmented region from the spatial domain to the frequency domain using techniques like the Fast Fourier Transform (FFT). This analysis allows the AR system to measure the high-frequency components, which correspond to rough textures. Regions with a high concentration of these components are identified as having rough textures. Additionally, the AR system may use statistical measures such as the variance of pixel intensities within the region to quantify texture roughness, with higher variance indicating rougher textures. By combining edge density, frequency analysis, and statistical measures, the AR system can identify rough textures within the background.

The AR system may also perform analysis of the roughness texture of available font textures. The available font textures may come from a text style database and/or from a plurality of available text styles (e.g., plurality of text styles 122 of FIG. 1). Based on the determined textures of the background and the available fonts, the AR system selects a font texture to apply to the text. The textured text (e.g., text 504) provides greater legibility while maintaining the preferred font color.

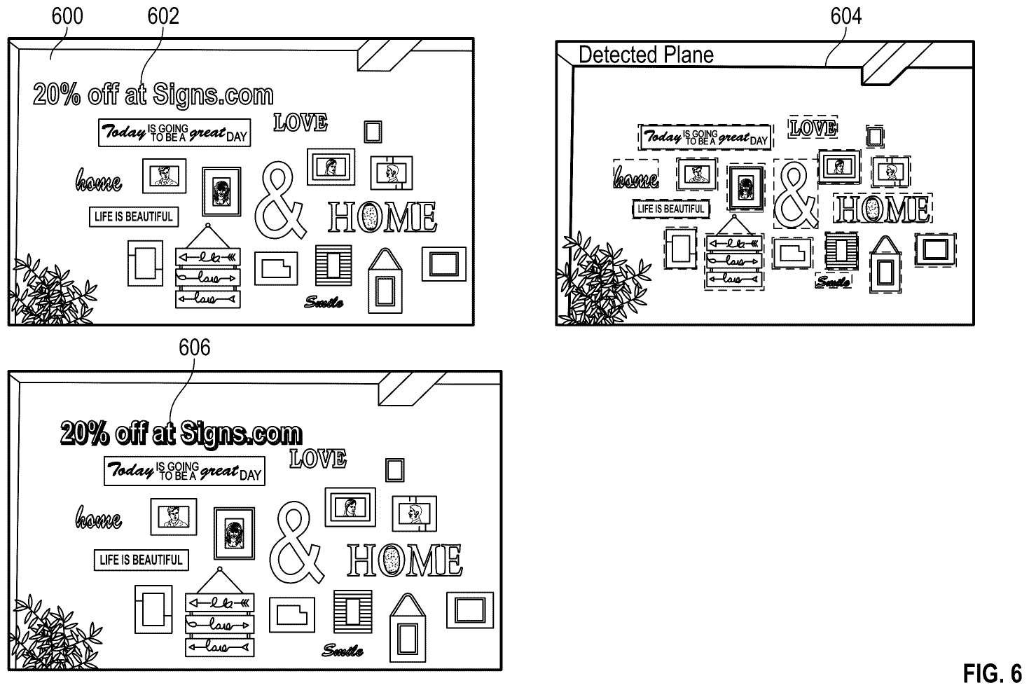

FIG. 6 shows an illustrative example of applying a parallax effect to text, in accordance with some embodiments of this disclosure. In some embodiments, an AR system (e.g., the AR system of FIG. 1) generates for display text (e.g., text 602) on a plane surface of a real-world object that is displayed within an AR environment (e.g., AR environment 600). When multiple objects (e.g., wall décor) are present on the same depth plane, they can appear cluttered which makes compromises the legibility of text 602. Part of this issue results from the lack of parallax. Adding and adjusting parallax can make text stand out by making text appear in a distinct way compared to other objects on the same plane. In some embodiments, the AR system generates for display text 606 offset from the detected wall plane (e.g., detected plane 604) so that text 606 is slightly larger and more legible among the wall décor. The shadow effect is added for emphasis but is not necessary.

In some implementations, the AR system achieves the parallax effect by identifying objects and the position of detected plane 604 they are attached to in the real-world environment corresponding to AR environment 600. After identifying a group of objects on depth plane 604, the AR system may identify the field of view taken up by each object, in visual angle or percent. The AR system may consider several additional features to determine whether to apply the parallax effect and to what degree. In addition to the number of objects and amount of field of view taken up, in some embodiments, the AR system identifies a section of detected plane 604 that contains the objects and calculates a separate occupied field of view value for that section. The AR system may use semantic segmentation (as described above in connection with FIG. 4) to identify text (e.g., text 602 and/or text 606) and non-text and weigh text more heavily when evaluating depth clutter.

With relevant parameters identified, the AR system may identify the optimal depth offset for the selected text. Too much similar depth offset among proximate objects may be distracting and may clutter other objects (real or AR). To prevent this, the AR system may apply a maximum or minimum offset value or determine this value dynamically based on other detected objects.

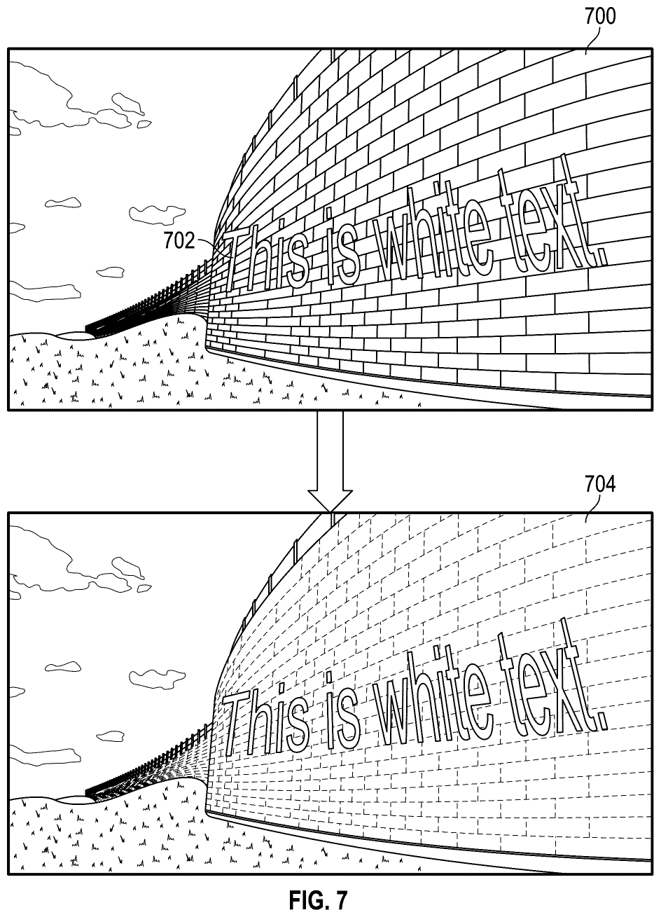

FIG. 7 shows an illustrative example of blurring rough background textures to increase text legibility, in accordance with some embodiments of this disclosure. In some embodiments, an AR system (e.g., the AR system of FIG. 1) generates for display text (e.g., text 702) on a plane surface of a real-world object that is displayed within an AR environment (e.g., AR environment 700). In some embodiments, the AR system dynamically adjusts the color, brightness (exposure), and texture of background objects (e.g., the wall on which text 702 is displayed) to enhance the legibility of text 702. In some implementations, the AR system analyzes AR environment 700 to determine the importance of objects within the background. Key objects (e.g., people or interactive elements) remain unaltered, while AR system may modify less critical background elements (e.g., walls or fences) to create a natural contrast with text 702.

Using pass-through cameras (e.g., a camera of HMD 102 as described above in connection with FIG. 1) to capture the real-world environment and segment it based on object recognition and importance, the AR system may perform semantic segmentation (as described above in connection with FIG. 4) to classify the various objects and distinguish between important features and background elements. Once the background elements are identified, the AR system selectively adjusts their color, brightness, or texture. The AR system may analyze the roughness texture of the background area using edge detection algorithms, such as the Sobel or Canny edge detectors which highlight areas with significant changes in intensity, indicating the presence of edges and fine details. Next, the AR system may perform frequency analysis by converting the segmented region from the spatial domain to the frequency domain using techniques like the Fast Fourier Transform (FFT). This analysis allows the AR system to measure the high-frequency components, which correspond to rough textures.

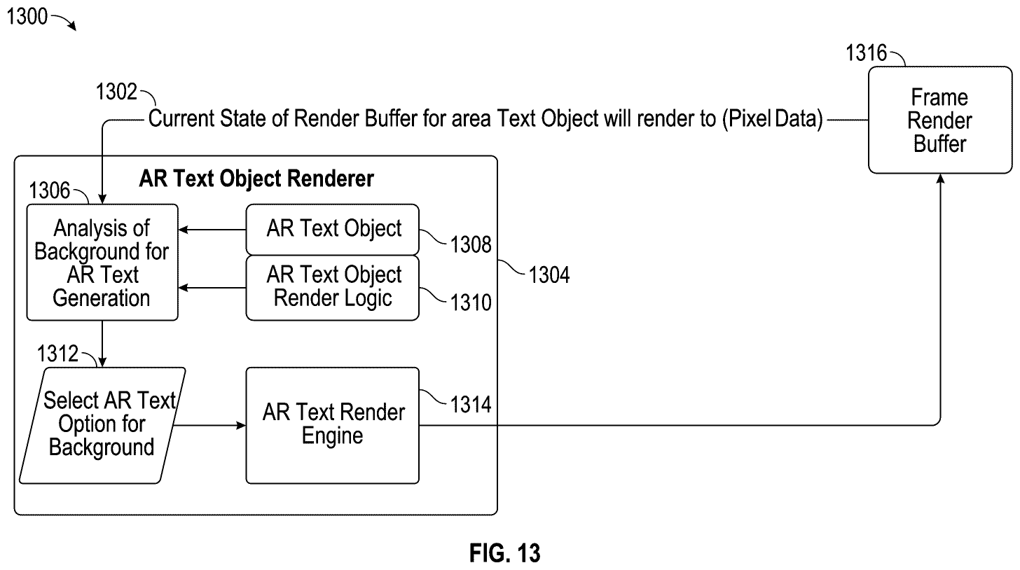

Regions with a high concentration of these components are identified as having rough textures. Additionally, the AR system may use statistical measures such as the variance of pixel intensities within the region to quantify texture roughness, with higher variance indicating rougher textures. By combining edge density, frequency analysis, and statistical measures, the AR system can identify rough textures within the background. Upon identifying these areas, the system applies smoothing filters, such as Gaussian blur or bilateral filtering, which reduce high-frequency noise and details while preserving essential edges. The AR system may integrate the smoothing process into the AR rendering pipeline (as described below in connection with FIG. 12-13), dynamically applying the filters to the background region behind the AR text in real-time. For example, it can darken a fence or wall behind the AR text to enhance contrast, while ensuring that moving or significant objects, such as people, are not altered. In another example, the AR system blurs and smooths the texture of the wall in, e.g., AR environment 704, to improve the legibility of text 702.

In some embodiments, the AR system may identify AR objects that occlude the placed AR text. In response, the AR system may modify the occluding AR objects based on a priority assigned by the AR application or the user. If the AR text is deemed by the system to be more important than the occluding object, the AR system may prioritize the AR text in the rendering pipeline so that it is rendered on top of the occluding AR text or physical objects. If the occluding object is an AR object, the system may adjust the transparency of the AR object to make the AR text more legible.

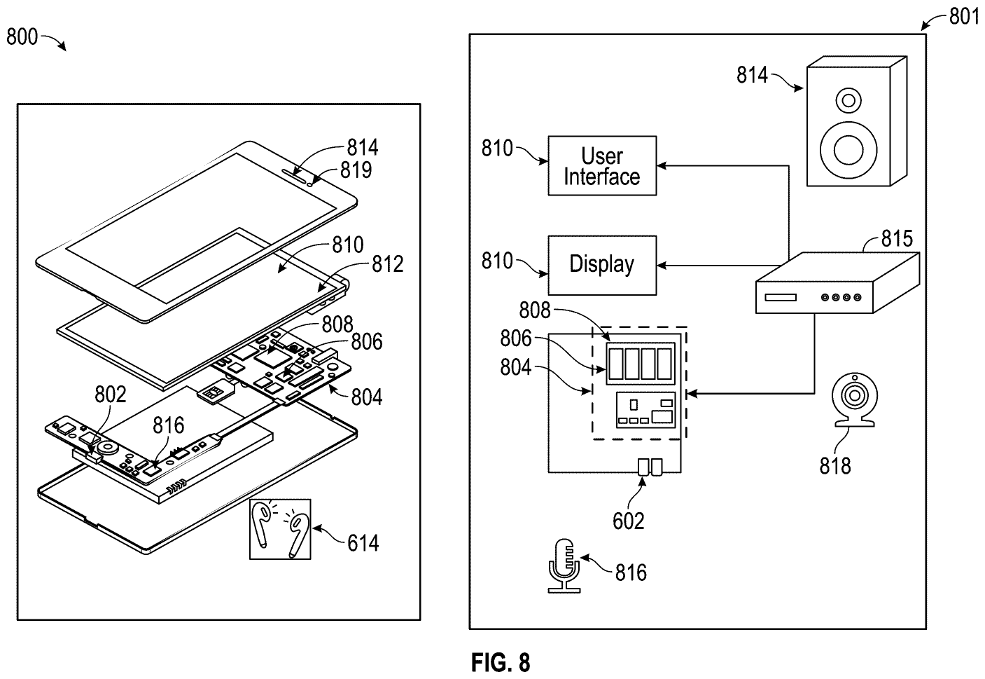

FIGS. 8-9 describe illustrative devices, systems, servers, and related hardware for selecting a text style to display in an AR environment based on predicted lighting conditions, in accordance with some embodiments of the present disclosure. FIG. 8 shows generalized embodiments of illustrative user equipment 800 and 801, which may correspond to, e.g., user device 114 of FIGS. 1A-1B. For example, user equipment 800 may be a smartphone device, a tablet, a near-eye display device, an XR device, or any other suitable device capable of participating in a XR environment, e.g., locally or over a communication network. In another example, user equipment 801 may be a user television equipment system or device. User equipment 801 may include set-top box 815. Set-top box 815 may be communicatively connected to microphone 816, audio output equipment 814 (e.g., speaker or headphones), and display 812. In some embodiments, microphone 816 may receive audio corresponding to a voice of a user and/or ambient audio data. In some embodiments, display 812 may be a television display or a computer display. In some embodiments, set-top box 815 may be communicatively connected to user input interface 810. In some embodiments, user input interface 810 may be a remote-control device. Set-top box 815 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 9. In some embodiments, user equipment 800 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment 800. In some embodiments, user equipment 800 comprises a rechargeable battery that is configured to provide power to the components of the device.

Each one of user equipment 800 and user equipment 801 may receive content and data via input/output (I/O) path 802. I/O path 802 may provide content (e.g., broadcast programming, on-demand programming, internet content, content available over a local area network (LAN) or wide area network (WAN), and/or other content) and data to control circuitry 804, which may comprise processing circuitry 806 and storage 808. Control circuitry 804 may be used to send and receive commands, requests, and other suitable data using I/O path 802, which may comprise I/O circuitry. I/O path 802 may connect control circuitry 804 to one or more communications paths (described below). I/O functions may be provided by one or more of these communications paths but are shown as a single path in FIG. 6 to avoid overcomplicating the drawing. While set-top box 815 is shown in FIG. 6 for illustration, any suitable computing device having processing circuitry, control circuitry, and storage may be used in accordance with the present disclosure. For example, set-top box 815 may be replaced by, or complemented by, a personal computer (e.g., a notebook, a laptop, a desktop), a smartphone (e.g., user equipment 800), an XR device, a tablet, a network-based server hosting a user-accessible client device, a non-user-owned device, any other suitable device, or any combination thereof.

Control circuitry 804 may be based on any suitable control circuitry such as processing circuitry 806. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 804 executes instructions for the system (as described in connection with FIGS. 1-3) stored in memory (e.g., storage 808). Specifically, control circuitry 804 may be instructed by the system to perform the functions discussed above and below. In some implementations, processing or actions performed by control circuitry 804 may be based on instructions received from the system.

In client/server-based embodiments, control circuitry 804 may include communications circuitry suitable for communicating with a server or other networks or servers. The system may be a stand-alone application implemented on a device or a server. The application may be implemented as software or a set of executable instructions. The instructions for performing any of the embodiments discussed herein of the application may be encoded on non-transitory computer-readable media (e.g., a hard drive, random-access memory on a DRAM integrated circuit, read-only memory on a BLU-RAY disk, etc.). For example, in FIG. 6, the instructions may be stored in storage 808, and executed by control circuitry 804 of a user equipment 800.

In some embodiments, the application may be a client/server application where only the client application resides on user equipment 800, and a server application resides on an external server (e.g., server 904 and/or media content source 902). For example, the application may be implemented partially as a client application on control circuitry 804 of user equipment 800 and partially on server 904 as a server application running on control circuitry 911. Server 904 may be a part of a local area network with one or more of user equipment 800, 801 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 904 and/or an edge computing device), referred to as “the cloud.” User equipment 800 may be a cloud client that relies on the cloud computing capabilities from server 904 to generate personalized engagement options in a VR environment.

Control circuitry 804 may include communications circuitry suitable for communicating with a server, edge computing systems and devices, a table or database server, or other networks or servers. The instructions for carrying out the above-mentioned functionality may be stored on a server (which is described in more detail in connection with FIG. 7). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 7). In addition, communications circuitry may include circuitry that enables peer-to-peer communication of user equipment, or communication of user equipment in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 808 may be used to store various types of content described herein as well as application data described above. Nonvolatile memory may also be used (e.g., to launch a boot-up routine and other instructions). Cloud-based storage, described in relation to FIG. 6, may be used to supplement storage 808 or instead of storage 808. Non-transitory memory may store instructions that, when executed by control circuitry, I/O circuitry, any other suitable circuitry or combination thereof, executes functions of an application as described above.

Control circuitry 804 may include video generating circuitry and tuning circuitry, such as one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 804 may also include scaler circuitry for upconverting and downconverting content into the preferred output format of user equipment 800. Control circuitry 804 may also include digital-to-analog converter circuitry and analog-to-digital converter circuitry for converting between digital and analog signals. The tuning and encoding circuitry may be used by user equipment 800, 801 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from user equipment 800, the tuning and encoding circuitry (including multiple tuners) may be associated with storage 808.

Control circuitry 804 may receive instruction from a user by way of user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of each one of user equipment 800 and user equipment 801. For example, display 812 may be a touchscreen or touch-sensitive display. In such circumstances, user input interface 810 may be integrated with or combined with display 812. In some embodiments, user input interface 810 includes a remote-control device having one or more microphones, buttons, keypads, any other components configured to receive user input or combinations thereof. For example, user input interface 810 may include a handheld remote-control device having an alphanumeric keypad and option buttons. In a further example, user input interface 810 may include a handheld remote-control device having a microphone and control circuitry configured to receive and identify voice commands and transmit information to set-top box 815.

Audio output equipment 814 may be integrated with or combined with display 812. Display 812 may be one or more of a monitor, television, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 812. Audio output equipment 814 may be provided as integrated with other elements of each one of user equipment 800 and user equipment 801 or may be stand-alone units. An audio component of videos and other content displayed on display 812 may be played through speakers (or headphones) of audio output equipment 814. In some embodiments, audio may be distributed to a receiver (not shown), which processes and outputs the audio via speakers of audio output equipment 814. In some embodiments, for example, control circuitry 804 is configured to provide audio cues to a user, or other audio feedback to a user, using speakers of audio output equipment 814. There may be a separate microphone 816 or audio output equipment 814 may include a microphone configured to receive audio input such as voice commands or speech. For example, a user may speak letters or words that are received by the microphone and converted to text by control circuitry 804. In a further example, a user may voice commands that are received by a microphone and recognized by control circuitry 804. Camera 818 may be any suitable video camera integrated with the equipment or externally connected. Camera 818 may be a digital camera comprising a charge-coupled device (CCD) and/or a complementary metal-oxide semiconductor (CMOS) image sensor. Camera 818 may be an analog camera that converts to digital images via a video card.

The application may be implemented using any suitable architecture. For example, it may be a stand-alone application wholly implemented on each one of user equipment 800 and user equipment 801. In such an approach, instructions of the application may be stored locally (e.g., in storage 808), and data for use by the application is downloaded on a periodic basis (e.g., from an out-of-band feed, from an internet resource, or using another suitable approach). Control circuitry 804 may retrieve instructions of the application from storage 808 and process the instructions to provide video conferencing functionality and generate any of the displays discussed herein. Based on the processed instructions, control circuitry 804 may determine what action to perform when input is received from user input interface 810. For example, movement of a cursor on a display up/down may be indicated by the processed instructions when user input interface 810 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), etc.

Control circuitry 804 may allow a user to provide user profile information or may automatically compile user profile information. For example, control circuitry 804 may access and monitor network data, video data, audio data, processing data, content consumption data, and/or any other suitable data being accessed by a first user. Control circuitry 804 may obtain all or part of other user profiles that are related to a particular user (e.g., via social media networks), and/or obtain information about the user from other sources that control circuitry 804 may access. As a result, a user can be provided with a unified experience across the user's different devices.

In some embodiments, the application is a client/server-based application. Data for use by a thick or thin client implemented on each one of user equipment 800 and user equipment 801 may be retrieved on demand by issuing requests to a server remote to each one of user equipment 800 and user equipment 801. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on user equipment 800. This way, the processing of the instructions is performed remotely by the server while the resulting displays (e.g., that may include text, a keyboard, or other visuals) are provided locally on user equipment 800. User equipment 800 may receive inputs from the user via user input interface 810 and transmit those inputs to the remote server for processing and generating the corresponding displays. For example, user equipment 800 may transmit a communication to the remote server indicating that an up/down button was selected via user input interface 810. The remote server may process instructions in accordance with that input and generate a display of the application corresponding to the input (e.g., a display that moves a cursor up/down). The generated display is then transmitted to user equipment 800 for presentation to the user.

In some embodiments, the application may be downloaded and interpreted or otherwise run by an interpreter or virtual machine (run by control circuitry 804). In some embodiments, the application may be encoded in the ETV Binary Interchange Format (EBIF), received by control circuitry 804 as part of a suitable feed, and interpreted by a user agent running on control circuitry 804. For example, the application may be an EBIF application. In some embodiments, the application may be defined by a series of JAVA-based files that are received and run by a local virtual machine or other suitable middleware executed by control circuitry 804. In some of such embodiments (e.g., those employing MPEG-2, MPEG-4, HEVC or any other suitable digital media encoding schemes), the application may be, for example, encoded and transmitted in an MPEG-2 object carousel with the MPEG audio and video packets of a program.

As shown in FIG. 9, user equipment 906, 907, 908, 910, 915 (which may correspond to user equipment, e.g., design device 100 of FIG. 1A and/or user device 114 of FIG. 1B) may be coupled to communication network 909. Communication network 909 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 909) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 7 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 909.

System 900 may comprise media content source 902, one or more servers 904, and/or one or more edge computing devices. In some embodiments, the application may be executed at one or more of control circuitry 911 of server 904 (and/or control circuitry of user equipment 906, 907, 908, 910, 915 and/or control circuitry of one or more edge computing devices). In some embodiments, the media content source and/or server 904 may be configured to host or otherwise facilitate video communication sessions between user equipment 906, 907, 908, 910, 915 and/or any other suitable user equipment, and/or host or otherwise be in communication (e.g., over communication network 909) with one or more social network services.

In some embodiments, server 904 may include control circuitry 911 and storage 914 (e.g., RAM, ROM, Hard Disk, Removable Disk, etc.). In some embodiments, storage 914 may store, in non-transitory computer readable memory, the code for all XR applications, middleware, and system described in connection with some embodiments of this disclosure. Storage 914 may store one or more databases. Server 904 may also include an I/O path 912. In some embodiments, I/O path 912 is an I/O circuitry. I/O circuitry may be a NIC card, audio output device, mouse, keyboard card, any other suitable I/O circuitry device or combination thereof. I/O path 912 may provide video conferencing data, device information, or other data, over a local area network (LAN) or wide area network (WAN), and/or other content and data to control circuitry 911, which may include processing circuitry, and storage 914. Control circuitry 911 may be used to send and receive commands, requests, and other suitable data using I/O path 912, which may comprise I/O circuitry. I/O path 912 may connect control circuitry 911 to one or more communications paths.

Control circuitry 911 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 911 executes instructions for an emulation system application stored in memory (e.g., the storage 914). Memory may be an electronic storage device provided as storage 914 that is part of control circuitry 911. Memory may store instruction to run the application.

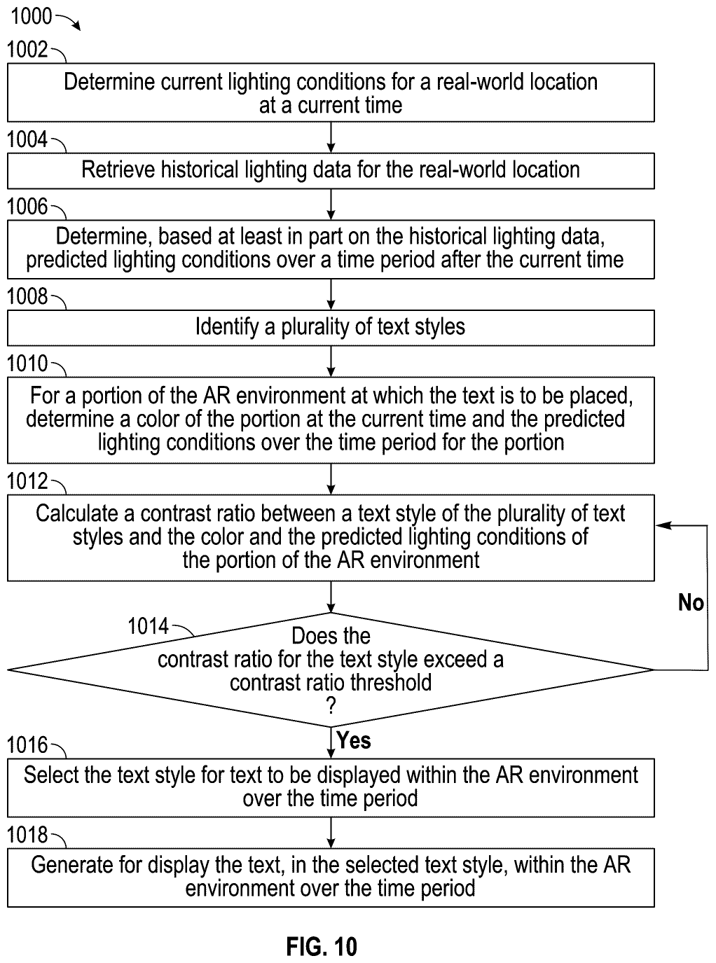

FIG. 10 is a flowchart of an illustrative process for selecting a text style to display in an AR environment based on predicted lighting conditions, in accordance with some embodiments of this disclosure. In various embodiments, the individual steps of process 1000 may be implemented by one or more components of the devices and systems of FIGS. 1-9 and may be performed in combination with any of the other processes and aspects described herein. Although the present disclosure may describe certain steps of process 1000 (and of other processes described herein) as being implemented by certain components of the devices and systems of FIGS. 1-9, this is for purposes of illustration only. It should be understood that other suitable components of the devices and systems may implement those steps instead.

In some embodiments, at 1002, control circuitry (e.g., control circuitry 804 of user equipment 800 and/or control circuitry 911 of server 904) determines current lighting conditions for a real-world location at a current time. For example, at 5 pm, control circuitry, via an AR device (e.g., HMD 102 of FIG. 1) running an AR system determines that the living room of an AR user (e.g., AR user 100) is filled with sunlight. In some embodiments, control circuitry generates for display an AR environment (e.g., AR environment 126 of FIG. 1) within the display of HMD 102. In some implementations, at 1004, control circuitry retrieves historical lighting data for the real-world location. For example, the historical lighting data (e.g., historical lighting data 106 of FIG. 1) for the living room may comprise an average luminance for the living room over at least one time period before the current time (e.g., the luminance of the living room for each hour over the past 24 hours). In some embodiments, at 1006, control circuitry determines, based at least in part on the historical lighting data, predicted lighting conditions over a time period after the current time. For example, based on the luminance of the living room over the past 24 hours, control circuitry predicts that the luminance of the living room will decrease between 5-8 pm due to shadows created by the setting sun against one of the walls of the living room.

In some implementations, at 1008, control circuitry identifies a plurality of text styles. For example, control circuitry identifies a plurality of text styles (e.g., plurality of text styles 122 of FIG. 1) from a text style database. In some embodiments, at 1010, control circuitry, for a portion of AR environment 126 at which the text is to be placed, determines a color of the portion at the current time and the predicted lighting conditions of the portion of the AR environment. In some implementations, at 1012, control circuitry calculates a contrast ratio between a text style of the plurality of text styles and the color and the predicted lighting conditions of the portion of the AR environment. Control circuitry may calculate the contrast ratio using techniques described above in connection with FIG. 1. In some embodiments, at 1014, control circuitry determines whether the contrast ratio for the text style exceeds a contrast ratio threshold. The contrast ratio threshold may be preset by the AR system as, e.g., 300:1. If control circuitry determines that the contrast ratio for the text style does not exceed a contrast ratio threshold, control circuitry may revert to 1012 for a different text style of the plurality of text styles. If control circuitry determines that the contrast ratio for the text style exceeds a contrast ratio threshold, control circuitry may proceed to 1016.

In some implementations, at 1016, control circuitry selects the text style for text to be displayed within the AR environment over the time period. For example, control circuitry selects a bold text style from plurality of text styles 122 based on determining that the lighting conditions of AR environment 126 are predicted to decrease over the time period of 5 pm-8 pm. In some embodiments, at 1018, control circuitry generates for display the text, in the selected text style, within AR environment 126 over the time period. For example, control circuitry generates for display “20% off socks from sockworld.com” in the selected, bold text style on the wall of the living room in AR environment 126.

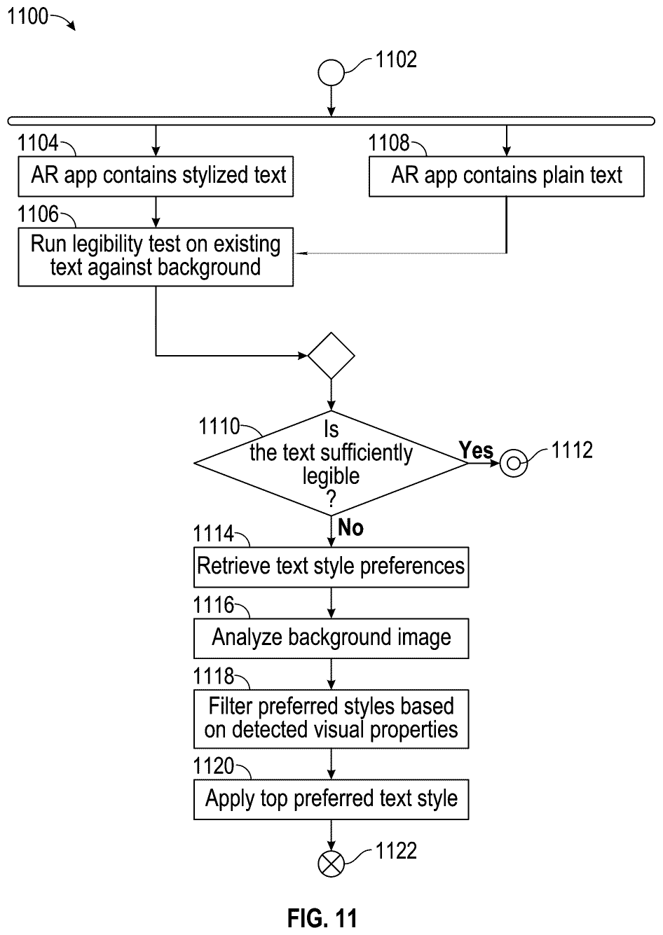

FIG. 11 is a flowchart of an illustrative process 1100 for selecting a text style to display in an AR environment based on predicted lighting conditions, in accordance with some embodiments of this disclosure. In various embodiments, the individual steps of process 1100 may be implemented by one or more components of the devices and systems of FIGS. 1-9 and may be performed in combination with any of the other processes and aspects described herein. Although the present disclosure may describe certain steps of process 1100 (and of other processes described herein) as being implemented by certain components of the devices and systems of FIGS. 1-9, this is for purposes of illustration only. It should be understood that other suitable components of the devices and systems may implement those steps instead. While process 1100 of FIG. 11 and other portions of this disclosure describe the selection of a text style for display in an AR environment, it should be appreciated that similar techniques of process 1100 and other portions of this disclosure may be employed to select from various versions or types of any suitable AR or virtual object to be presented in AR.

In some implementations, at 1102, process 1100 begins. In some embodiments, at 1104, control circuitry (e.g., control circuitry 804 of user equipment 800 and/or control circuitry 911 of server 904) identifies an AR application (app) that contains stylized text. For example, control circuitry identifies an AR game app that displays advertising text to AR users of the game that is stylized based on branding requirements. In some implementations, at 1108, control circuitry identifies that the AR app also contains plain text. For example, control circuitry determines that the AR app also displays game instructions in non-stylized text. In some embodiments, at 1106, control circuitry runs a legibility test on the text against the background. For example, control circuitry may calculate the contrast ratio between the text and the background reaches a contrast ratio threshold, as described above in connection with FIG. 1.

In some implementations, at 1110, control circuitry determines whether the text is sufficiently legible. For example, control circuitry may determine if the contrast ratio between the text and the background reaches a contrast ratio threshold, as described above in connection with FIG. 1. If control circuitry determines that the text is sufficiently legible, control circuitry may halt at 1112. If control circuitry determines that the text is not sufficiently legible, control circuitry may proceed to 1114 and retrieve text style preferences. In some embodiments, control circuitry determines user color preferences from prior AR sessions. In some implementations, control circuitry receives explicit (or implicit) user preferences of text styles, e.g., outlined, extruded, or any other suitable text style, or any combination thereof. The list of user-preferred text styles may be ranked by preference level. In some embodiments, control circuitry determines text style preferences of a brand advertising via AR text. In some embodiments, at 1116, control circuitry analyzes the background image. Control circuitry may analyze the background using techniques described in connection with FIG. 1. Control circuitry may analyze video footage from pass-through cameras to determine environmental visual features such as, for example, background color, segmented regions, lighting conditions, or any other suitable data, or any suitable combination thereof.

In some implementations, at 1118, control circuitry filters preferred styles based on detected visual properties. Based on the combination of detected visual features, control circuitry may select a text style and position that ensures legibility. Control circuitry may make text style adjustments such as adjusting text color or position based on current or predicted lighting, adjusting text distance from the user to make text stand out, adjusting font texture, or blurring segmented background objects. In some embodiments, at 1120, control circuitry applies the top preferred text style.

FIG. 12 is a flowchart of an illustrative process 1200 for rendering an AR text object, in accordance with some embodiments of this disclosure. In various embodiments, the individual steps of process 1200 may be implemented by one or more components of the devices and systems of FIGS. 1-9 and may be performed in combination with any of the other processes and aspects described herein. Although the present disclosure may describe certain steps of process 1200 (and of other processes described herein) as being implemented by certain components of the devices and systems of FIGS. 1-9, this is for purposes of illustration only. It should be understood that other suitable components of the devices and systems may implement those steps instead.

In some implementations, control circuitry (e.g., control circuitry 804 of user equipment 800 and/or control circuitry 911 of server 904) generates for display an AR environment scene within an AR headset (e.g., HMD 102 of FIG. 1). In some embodiments, renderer pipeline 1202, via control circuitry, receives background fill from headset cameras (e.g., HMD 102 of FIG. 1) at 1206. Renderer pipeline 1202 sends the background fill data to frame renderer buffer 1204. In some embodiments, using any of 3D AR object renderers 1208, 1210, 1214, and/or 1216, control circuitry takes all of the 2D and 3D objects in a scene and renders them to a 2D plane for display to an AR user (e.g., AR user 100 of FIG. 1) with the correct lighting and post processing effects. Each 3D AR object renderer may be used to render a different AR object. For pass-through AR, this is rendered on top of the physical world that is passed through by cameras in HMD 102 to allow for the merging of the physical and virtual worlds.

AR text object renderer 1212 mathematically determines where the AR text object will be rendered to in frame renderer buffer 1204, which contains the actual pixels that the user's eyes will see and is the result of renderer pipeline 1202. Renderer pipeline 1202 may render the 3D objects in the scene starting from the far clipping plane as far away from the eye as possible and then continue to move towards the near clipping plane closest to the user's eyes. This allows the closer 3D objects to overwrite the more distant objects in frame render buffer 1204 and make the rendered objects appear correctly to the user. This defined region of frame render buffer 1204 is to be written to at the time of this evaluation so that the evaluation logic has exactly what the AR text object will be rendered over to analyze for the best possible solution for the AR text object against the given background for that rendered frame. This evaluation will also need to happen after the lighting and post-processing of all of the 3D objects has been completed to give the most accurate data for evaluation.

In some embodiments, control circuitry (e.g., control circuitry 804 of user equipment 800 and/or control circuitry 911 of server 904) updates render pipeline 1202 to allow for the evaluation of the combination of the physical world and any rendered AR objects that the text is to overlay. AR text objects may be anchored within the 3D environment to a physical location or used as overlays that are rendered on top of all other AR objects in the scene.

FIG. 13 is a flowchart of an illustrative process 1300 for rendering an AR text object, in accordance with some embodiments of this disclosure. In various embodiments, the individual steps of process 1300 may be implemented by one or more components of the devices and systems of FIGS. 1-9 and may be performed in combination with any of the other processes and aspects described herein. Although the present disclosure may describe certain steps of process 1300 (and of other processes described herein) as being implemented by certain components of the devices and systems of FIGS. 1-9, this is for purposes of illustration only. It should be understood that other suitable components of the devices and systems may implement those steps instead.

In some implementations, control circuitry (e.g., control circuitry 804 of user equipment 800 and/or control circuitry 911 of server 904) generates for display an AR environment scene within an AR headset (e.g., HMD 102 of FIG. 1). Process 1300 highlights the additional functionality of the AR text object renderer of adding the current render buffer data and using AR text object render logic 1310 to analyze the scene to determine the best AR Text option (e.g., at 1312) to then render and deliver to frame render buffer 1316 for viewing by the user. In some embodiments, at 1302, frame render buffer 1316 sends pixel data of the current state of frame render buffer 1316 for the area of the AR environment that AR text object 1308 will render to. The AR text object renderer may identify the region of frame render buffer 1316 where the AR text will be displayed based on the received pixel data.

As the 3D scene is rendered, at 1306, the AR text object renderer analyzes the background for AR text generation. In some embodiments, at 1312, the AR text object renderer selects an AR text option for the background. The AR text option may be a text style such as a color or font. Before rendering the text, the AR text object renderer, via control circuitry, may modify the background elements in this region, adjusting their color or brightness to ensure that the AR text stands out clearly. This ensures that the text remains legible without the need for intrusive banners or outlines, preserving the natural appearance of the scene. In some implementations, the AR text object renderer renders AR text object 1308 via AR text render engine 1314. AR text render engine 1314 may render objects starting from the far clipping plane towards the near clipping plane. AR text render engine 1314 may first render the background elements with the adjusted properties, followed by AR text object 1308. This allows the text to be superimposed on a naturally contrasting background, enhancing readability while maintaining the desired text style.

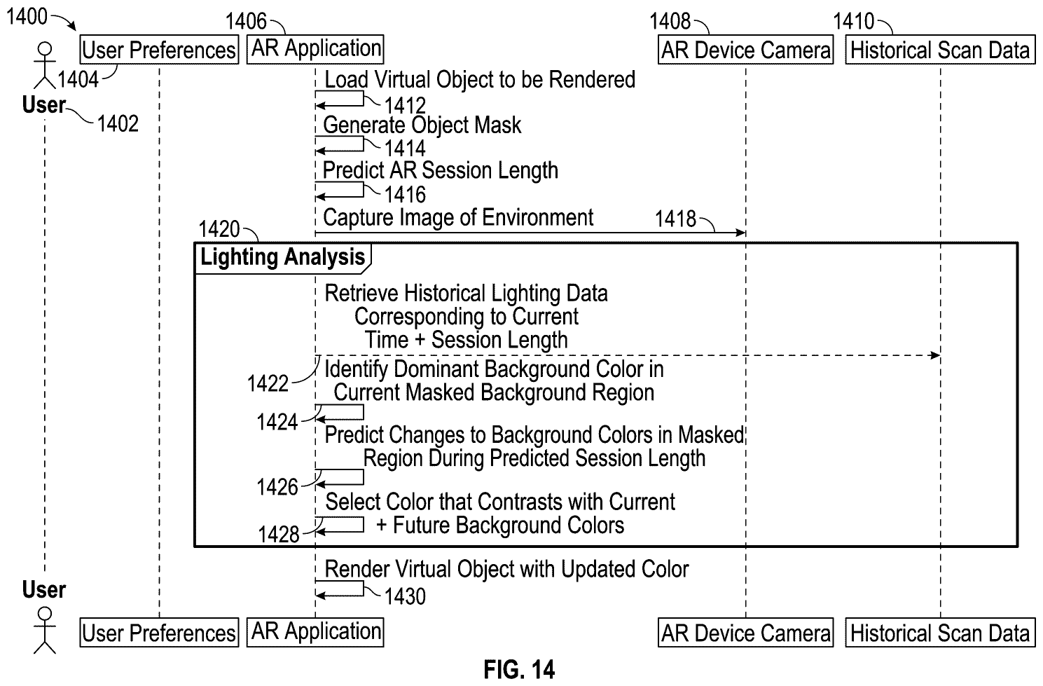

FIG. 14 is a sequence diagram of an illustrative process 1400 for selecting a text color based on predicted lighting changes, in accordance with some embodiments of this disclosure. In various embodiments, the individual steps of process 1400 may be implemented by one or more components of the devices and systems of FIGS. 1-9 and may be performed in combination with any of the other processes and aspects described herein. Although the present disclosure may describe certain steps of process 1400 (and of other processes described herein) as being implemented by certain components of the devices and systems of FIGS. 1-9, this is for purposes of illustration only. It should be understood that other suitable components of the devices and systems may implement those steps instead.

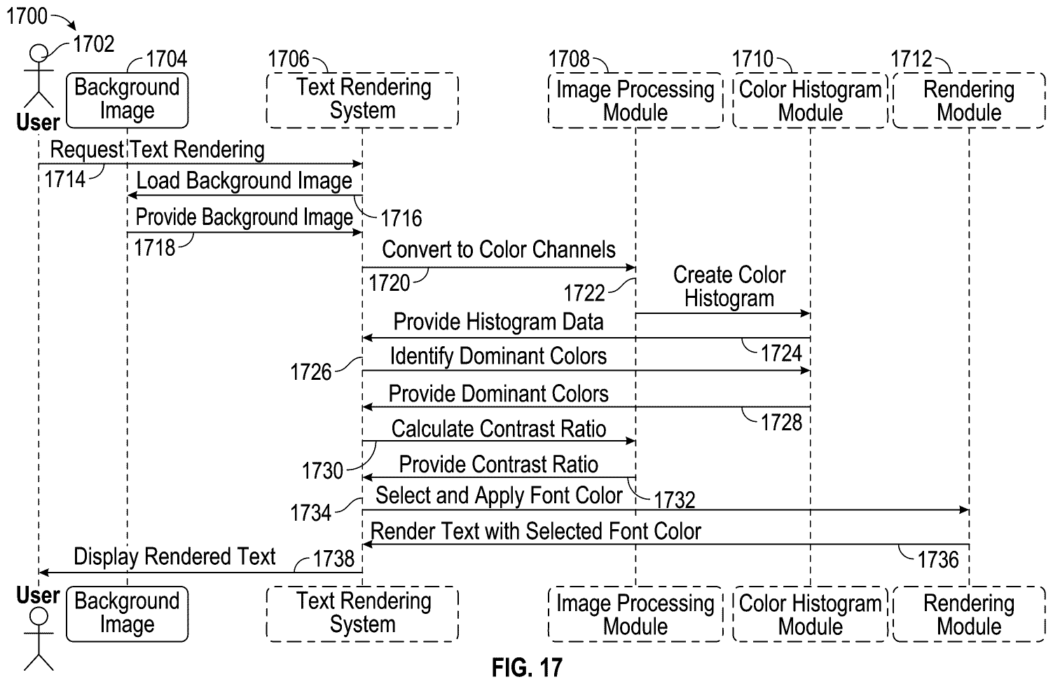

Process 1400 may use techniques described below in connection with FIG. 17. AR Application 1406 may run the AR system as described above in connection with FIG. 1. In some embodiments, at 1412, AR Application 1406 loads a virtual object to be rendered. The virtual object may be AR text or any other suitable AR virtual object. In some implementations, at 1414, AR Application 1406 generates an object mask for the virtual object. For example, the object mask may exclude objects in the background image other than the virtual object. In some embodiments, at 1416, AR Application 1406 predicts an AR session length. AR Application 1406 may predict the AR session length using techniques described above in connection with FIG. 1. In some implementations, at 1418, AR Application 1406 captures an image of the environment via AR device camera 1408. AR device camera 1408 may be part of a larger AR device such as HMD 102 of FIG. 1.

In some embodiments, at 1420, AR Application 1406 begins lighting analysis. In some implementations, at 1422, AR Application 1406 retrieves historical lighting data corresponding to the current time and AR session length from historical scan data 1410. Historical scan data 1410 may be a database of historical lighting data stored in memory of HMD 102 or stored at a remote server. In some embodiments, at 1424, AR Application 1406 identifies a dominant background color in the current masked background region via historical scan data 1410. AR Application 1406 may use techniques described in connection with FIG. 17. In some implementations, at 1426, AR Application 1406 predicts changes to background colors in the masked region during the predicted AR session length. In some embodiments, at 1428, AR Application 1406, selects a color that contrasts with current and future background colors. AR Application 1406 may select a color based on user preferences (e.g., user preferences 1404 of user 1402) stored in memory of HMD 102. In some implementations, at 1430, AR Application 1406 renders the virtual object with updated color. AR Application 1406 may render the virtual object using techniques described in connection with FIGS. 12-13.

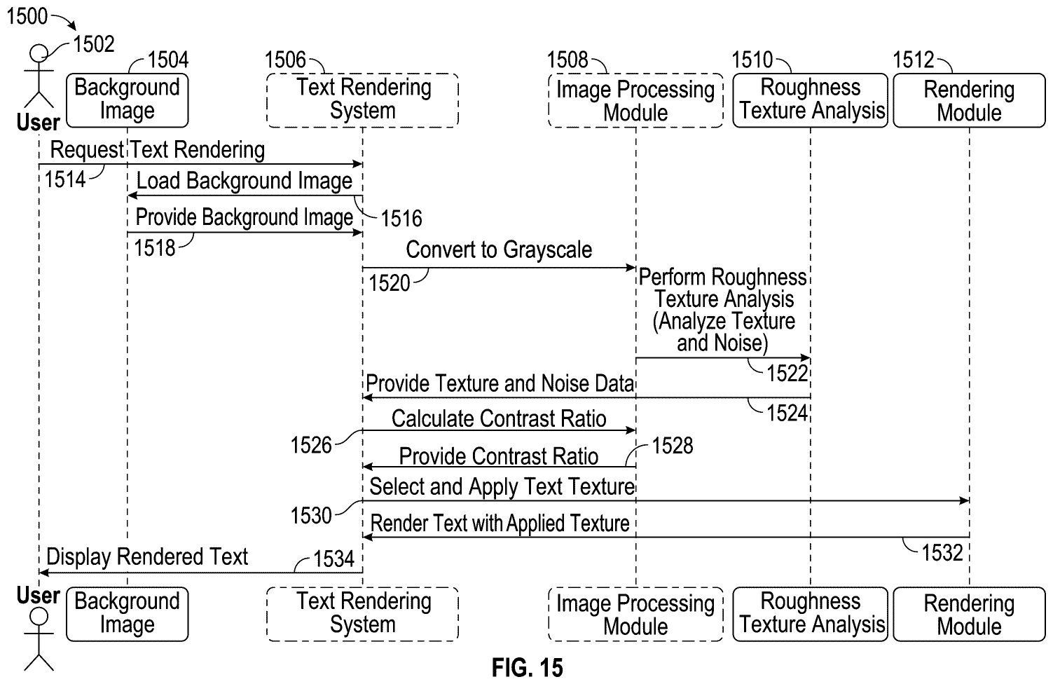

FIG. 15 is a sequence diagram of an illustrative process 1500 for selecting a texture for text based on the noise and texture of the background behind the text, in accordance with some embodiments of this disclosure. In various embodiments, the individual steps of process 1500 may be implemented by one or more components of the devices and systems of FIGS. 1-9 and may be performed in combination with any of the other processes and aspects described herein. Although the present disclosure may describe certain steps of process 1500 (and of other processes described herein) as being implemented by certain components of the devices and systems of FIGS. 1-9, this is for purposes of illustration only. It should be understood that other suitable components of the devices and systems may implement those steps instead.

The AR system as described above in connection with FIG. 1 may comprise text rendering system 1506, image processing module 1508, roughness texture analysis 1510, and/or rendering module 1512. In some embodiments, at 1514, user 1500 requests text rendering from text rendering system 1506. In some implementations, at 1516, text rendering system 1506 loads background image from background image 1504. Background image 1504 may be a database of background images, an AR application running the AR system of FIG. 1, any other suitable image storage, or any combination thereof. In some embodiments, at 1518, background image 1504 provides the background image to text rendering system 1506. In some implementations, at 1520, text rendering system 1506 sends the background image to image processing module 1508 to convert to grayscale. Image processing module 1508 convers the image to grayscale to simplify the texture analysis and focus on intensity variations. In some embodiments, at 1522, image processing module 1508 sends the background image to roughness texture analysis 1510 to perform roughness texture analysis on the background image. Roughness texture analysis 1510 may combine the results from edge density analysis, frequency analysis, and statistical measures to assess the roughness of the background texture and identify regions with significant texture or noise levels that might affect text legibility.

Roughness texture analysis 1510 may also perform roughness texture analysis on all available font textures, obtaining roughness metrics for each. Roughness texture analysis 1510 may store these metrics to use during the texture selection process. In some implementations, at 1524, roughness texture analysis 1510 provides texture and noise data to text rendering system 1506. In some embodiments, at 1526, text rendering system 1506 calculates a contrast ratio via image processing module 1508. Image processing module 1508 may determine the average intensity of the background in the region where the text will be placed. Image processing module 1508 may calculate the contrast ratio between the background intensity and the desired text color. In some implementations, at 1528, image processing module 1508 provides the contrast ratio to text rendering system 1506.

In some embodiments, at 1530, text rendering system 1506 selects and applies text texture and sends the text texture to rendering module 1512. Text rendering system 1506 may choose a texture that has a contrast ratio above a contrast ratio threshold as described above in connection with FIG. 1. More textured fonts may be used for smoother backgrounds while smoother fonts may be used for highly textured backgrounds. Text rendering system 1506 may adjust the texture selection based on the size of the image and the font. Larger images and fonts may require more pronounced textures for visibility, while smaller images and fonts may need more subtle textures to avoid visual clutter. In some implementations, at 1532, rendering module 1512 sends the rendered text with applied texture to text rendering system 1506. Rendering module 1512 renders the text with the selected texture using a graphical rendering technique such as OpenGL or DirectX. Text rendering system 1506 may adjust the text positioning and texture application to maintain readability and visual appeal. In some embodiments, at 1534, text rendering system 1506 displays the rendered text to user 1502. Text rendering system 1506 may validate the final text overlay to ensure it meets readability standards and blends seamlessly with the image.

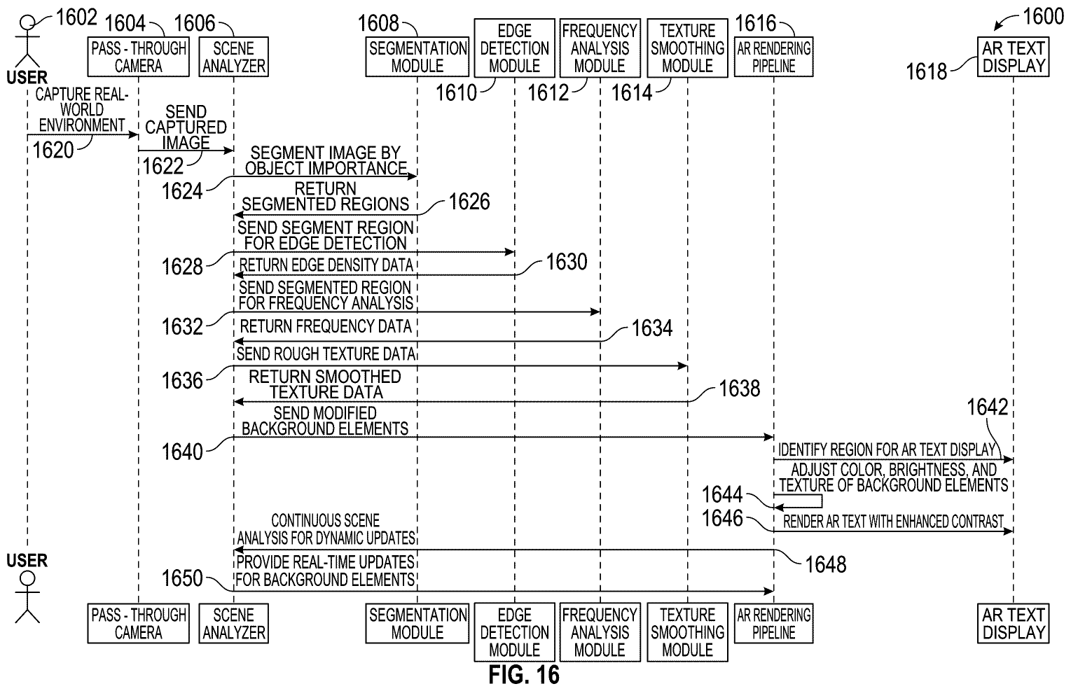

FIG. 16 is a sequence diagram of an illustrative process 1600 for blurring rough background textures to increase text legibility, in accordance with some embodiments of this disclosure. In various embodiments, the individual steps of process 1600 may be implemented by one or more components of the devices and systems of FIGS. 1-9 and may be performed in combination with any of the other processes and aspects described herein. Although the present disclosure may describe certain steps of process 1600 (and of other processes described herein) as being implemented by certain components of the devices and systems of FIGS. 1-9, this is for purposes of illustration only. It should be understood that other suitable components of the devices and systems may implement those steps instead.

Process 1600 uses the techniques described above in connection with FIG. 7. The AR system as described above in connection with FIG. 1 may comprise scene analyzer 1606, segmentation module 1608, edge detection module 1610, frequency analysis module 1612, texture smoothing module 1614, and/or AR rendering pipeline 1616. In some embodiments, at 1620, user 1602 captures an image of real-world environment via pass-through camera 1604. In some implementations, at 1622, pass-through camera 1604 sends the captured image to scene analyzer 1606. In some embodiments, at 1624, scene analyzer 1606 sends a segment image by object importance to segmentation module 1608.

In some implementations, at 1626, segmentation module 1608 returns segmented regions to scene analyzer 1606. In some embodiments, at 1628, scene analyzer 1606 sends segment region for edge detection to edge detection module 1610. In some implementations, at 1630, edge detection module 1610 returns the edge density data to scene analyzer 1606. In some embodiments, at 1632, scene analyzer 1606 sends the segmented region for frequency analysis to frequency analysis module 1612. In some implementations, at 1634, frequency analysis module 1612 returns the frequency data to scene analyzer 1606. In some embodiments, at 1636, scene analyzer 1606 sends rough texture data to texture smoothing module 1614. In some implementations, at 1638, texture smoothing module 1614 returns the smoothed texture data to scene analyzer 1606.

In some embodiments, at 1640, scene analyzer sends modified background elements to AR rendering pipeline 1616. In some implementations, at 1642, AR rendering pipeline 1616 identifies and sends a region for AR text display to AR text display 1618. In some embodiments, at 1644, AR rendering pipeline 1616 adjusts color, brightness, and texture of background elements. In some implementations, at 1646, AR rendering pipeline 1616 sends rendered AR text with enhanced contrast to AR text display 1618. In some embodiments, at 1648, AR rendering pipeline 1616 performs continuous scene analysis for dynamic updates via scene analyzer 1606. In some implementations, at 1650, scene analyzer 1606 provides real-time updates for background elements to AR rendering pipeline 1616.

FIG. 17 is a sequence diagram of an illustrative process for selecting a font color for text overlaid on images by analyzing dominant colors in the background using a color histogram, in accordance with some embodiments of this disclosure. In various embodiments, the individual steps of process 1700 may be implemented by one or more components of the devices and systems of FIGS. 1-9 and may be performed in combination with any of the other processes and aspects described herein. Although the present disclosure may describe certain steps of process 1700 (and of other processes described herein) as being implemented by certain components of the devices and systems of FIGS. 1-9, this is for purposes of illustration only. It should be understood that other suitable components of the devices and systems may implement those steps instead.

The AR system as described above in connection with FIG. 1 may comprise text rendering system 1706, image processing module 1708, color histogram module 1710, and/or rendering module 1712. In some embodiments, at 1714, user 1702 requests text rendering from text rendering system 1706. In some implementations, at 1716, text rendering system 1706 loads a background image from background image 1704. Background image 1704 may be a database of background images, an AR application running the AR system of FIG. 1, any other suitable image storage, or any combination thereof. In some embodiments, at 1718, background image 1704 provides the background image to text rendering system 1706. In some implementations, at 1720, text rendering system 1706 sends the background image to image processing module 1708 to convert to color channels (e.g., RGB) to facilitate color analysis. In some embodiments, at 1722, image processing module 1708 sends the converted background image to color histogram module 1710 to create a color histogram. Color histogram module 1710 creates a histogram for each color channel, representing the distribution of color intensities across the image. The histogram counts the number of pixels for each intensity value in each color channel.

In some implementations, at 1724, color histogram module 1710 provides histogram data to text rendering system 1706. In some embodiments, at 1726, text rendering system 1706 identifies dominant color in the background image via color histogram module 1710. The peaks in the histogram are identified, indicating the image's dominant colors. The peaks correspond to the most frequent color intensities in the image. In some implementations, at 1728, color histogram module 1710 provides the dominant colors to text rendering system 1706. In some embodiments, at 1730, text rendering system 1706 calculates the contrast ratio between potential font colors and the identified dominant colors via image processing module 1708. For example, image processing module uses a contrast ratio formula to quantify the difference in brightness between the background and the font color.

In some implementations, at 1732, image processing module 1708 provides the contrast ratio to text rendering system 1706. In some embodiments, at 1734, text rendering system 1706 selects and applies font color via rendering module 1712. Rendering module 1712 may select a font color that contrasts well with the dominant background colors (e.g., a light color font for a dark color background). The font color is selected to enhance readability and aesthetically integrate with the image. In some implementations, at 1736, rendering module 1712 renders the text with the selected font color and sends the rendered text to text rendering system 1706. Rendering module 1712 may apply the selected font color to the text using graphical rendering techniques such as OpenGL or DirectX. Rendering module 1712 may adjust the text positioning and font size to maintain readability and visual appeal. In some embodiments, at 1738, text rendering system 1706 displays the rendered text to user 1702. Text rendering system 1706 may validate the final text overlay to ensure it meets readability standards and blends seamlessly with the image.

In some embodiments, text rendering system 1706 comprises an additional subsystem to evaluate all of the text render solutions the system can generate for the AR text object and score them based on readability as they may be rendered in the AR scene. This may allow for the solution to switch to another rendered variation based on changes to the background, user movement that changes the view relative to the background and other rendered AR content or changes to the AR content that is behind the text. This embodiment may change the solution stack as each text render option may be rendered as part of the graphics pipeline individually to be evaluated by this new text legibility module as the decision is made after the rendering of the text.

Additionally, text rendering system 1706 may allow for better tracking of any masking of an AR text element by other AR rendered elements or physical world objects if it being placed in the scene as an anchored element to a specific physical world location. This may then allow text rendering system 1706 to either modify the AR rendered elements that are blocking part of the text based on some priority logic if the text is deemed by text rendering system 1706 to be more important to highlight to the user than the blocking AR elements could be made more translucent to allow better viewing of the text or by bringing the text forward in the rendering pipeline so that it is rendered on top of the blocking AR or physical objects. This visual system may be similar to current optical character recognition (OCR) systems used to recognize text within a digital image. However, current OCR systems are not designed to mimic the human eye to evaluate the text for both legibility and contrast in relation to the overall scene. Text rendering system 1706 may also include input from the end user to allow for their specific preferences to be included in the evaluation process.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
determining current lighting conditions for a real-world location at a current time;
retrieving historical lighting data for the real-world location;
determining, based at least in part on the historical lighting data, predicted lighting conditions over a time period after the current time;
based at least in part on the current lighting conditions for the real-world location at the current time and the predicted lighting conditions over the time period, selecting a text style for text to be displayed within an augmented reality (AR) environment over the time period, wherein the AR environment comprises the text overlaid on the real-world location; and
generating for display the text, in the selected text style, within the AR environment over the time period.

2. The method of claim 1, further comprising:
determining the time period based at least in part on a predicted AR session length.

3. The method of claim 1, further comprising:
based at least in part on the historical lighting data for the real-world location and the current lighting conditions for the real-world location, generating a lighting condition model; and
using the lighting condition model to determine the predicted lighting conditions over the time period,
wherein the lighting condition model comprises at least one neural network.

4. The method of claim 3, further comprising:
prior to the determining the predicted lighting conditions:
training the at least one neural network using the historical lighting data for the real-world location, wherein the historical lighting data comprises a plurality of lighting characteristics for a plurality of previous times, respectively, wherein each lighting characteristic is associated with at least one of a time of day or weather conditions at the corresponding previous time.

5. The method of claim 4, wherein determining the predicted lighting conditions further comprises:
inputting data indicative of the current lighting conditions, the time period, and at least one of the time of day or weather conditions of the current time to the trained at least one neural network; and
receiving as output, from the trained at least one neural network, data indicating the predicted lighting conditions over the time period.

6. The method of claim 1, further comprising:
based at least in part on the current lighting conditions for the real-world location at the current time and the predicted lighting conditions over the time period, selecting a position within the AR environment to display the text,
wherein the text is generated for display, in the selected text style, at the position within the AR environment.

7. The method of claim 6, wherein:
determining the predicted lighting conditions over the time period comprises determining, for each respective portion of a plurality of portions of the real-world location, a likelihood of changing lighting conditions; and
selecting the position comprises selecting a position in the AR environment to insert the text that corresponds to a portion of the plurality of portions having a likelihood of changing lighting conditions that is below a threshold.

8. The method of claim 1, wherein the AR environment is displayed at an AR device, and wherein the AR device is associated with a user profile, the method further comprising:
retrieving user preference data from the user profile,
wherein the selecting the text style for the text is based at least in part on the user preference data.

9. The method of claim 1, wherein the selecting the text style for the text further comprises:
identifying a plurality of text styles;
for a portion of the AR environment at which the text is to be placed, determining a color of the portion at the current time and the predicted lighting conditions over the time period for the portion;
calculating a contrast ratio between each of the plurality of text styles and the color and the predicted lighting conditions of the portion of the AR environment; and
selecting, as the text style, a text style of the plurality of text styles exceeding a contrast ratio threshold.

10. The method of claim 1, wherein the selecting the text style comprises:
based at least in part on the current lighting conditions for the real-world location at the current time and the predicted lighting conditions over the time period, selecting at least one of a color or a texture for the text to be displayed within the AR environment.

11. The method of claim 1, wherein the historical lighting data comprises an average luminance for the real-world location over at least one time period before the current time.

12. The method of claim 1, wherein the selected text style is maintained in the AR environment throughout the time period.

13. The method of claim 1, wherein the selected text style is a first selected text style displayed at a first time during the time period, the method further comprising:
during the time period, selecting a second text style for the text, based at least in part on the predicted lighting conditions over the time period; and
generating for display the text, in the second selected text style, within the AR environment at a second time during the time period, wherein the second time is later than the first time.

14. The method of claim 1, wherein selecting the text style is further based on whether the text is on a same depth plane as at least one other object in the AR environment.

15. The method of claim 1, further comprising modifying a color of a portion of the AR environment on which the selected text is placed.

16. The method of claim 1, wherein the predicted lighting conditions comprise at least one of an average luminance for the real-world location over the time period, a light color, a light color temperature, a light hardness, or shadow positioning.

17. A system comprising:
control circuitry configured to:
determine current lighting conditions for a real-world location at a current time;
retrieve historical lighting data for the real-world location;
determine, based at least in part on the historical lighting data, predicted lighting conditions over a time period after the current time;
based at least in part on the current lighting conditions for the real-world location at the current time and the predicted lighting conditions over the time period, select a text style for text to be displayed within an augmented reality (AR) environment over the time period, wherein the AR environment comprises the text overlaid on the real-world location; and
input/output circuitry configured to:
generate for display the text, in the selected text style, within the AR environment over the time period.

18. The system of claim 17, wherein the control circuitry is further configured to:
determine the time period based at least in part on a predicted AR session length.

19. The system of claim 17, wherein the control circuitry is further configured to:
based at least in part on the historical lighting data for the real-world location and the current lighting conditions for the real-world location, generate a lighting condition model; and
use the lighting condition model to determine the predicted lighting conditions over the time period,
wherein the lighting condition model comprises at least one neural network.

20. The system of claim 19, wherein the control circuitry is further configured to:
prior to the determining the predicted lighting conditions:
train the at least one neural network using the historical lighting data for the real-world location, wherein the historical lighting data comprises a plurality of lighting characteristics for a plurality of previous times, respectively, wherein each lighting characteristic is associated with at least one of a time of day or weather conditions at the corresponding previous time.

21-80. (canceled)
